(19) United States
(12) Patent Application Publication
(10) Pub. No.: US 2016/0037782 A1
(43) Pub. Date: Feb. 11, 2016

(54) COMBINATIONS OF ANTIFUNGAL COMPOUNDS AND TEA TREE OIL

(71) Applicant: Moshe REUVENI, Katzrin (IL)

(72) Inventor: Moshe REUVENI, Katzrin (IL)

(21) Appl. No.: 14/356,890

(22) PCT Filed: Nov. 8, 2012
(86) PCT No.: PCT/IB2012/056263

§ 371 Date: May 8, 2014

Related U.S. Application Data
(60) Provisional application No. 61/557,827, filed on Nov. 9, 2011.

(51) Int. Cl. A01N 65/28; A01N 59/20; A01N 43/54; A01N 43/653

(52) U.S. Cl. CPC A01N 65/28; A01N 43/653; A01N 59/20; A01N 43/54

(57) ABSTRACT

There is disclosed a method for treating a plant infection caused by a fungus of the phylum basidiomycota, comprising applying to the plant a combination of tea tree oil (TTO) and a synthetic fungicidal compound. Other embodiments are also disclosed.

### RELATED APPLICATIONS

This application claims priority from U.S. provisional application No. 61/557,827, filed Nov. 9, 2011 and entitled “Combinations of Antifungal Compounds and Tea Tree Oil”. The contents of this application are incorporated herein by reference.

### BACKGROUND

Infection of crops by fungi is a well-documented problem that can significantly affect crop yields. Various treatments of fungi by synthetic (chemical) products (including both curative and prophylactic treatments) have been developed, but they present problems as well. One problem, for example, is the effect of the so-called chemical load on the environment, animal and human health, and food safety. For these and other reasons, the popularity of “organic” or “bio-” fungicides, i.e. those derived from natural sources, has increased in recent years.

An additional problem encountered with the use of synthetic antifungal compounds, noticed by the early 1970's, is that resistance to such antifungal compounds sometimes develops. For example, the classes of antifungal compounds known as DMIs and strobilurins (discussed below) are biochemically active on a specific target site, and their broad use has led to fungal strains becoming less sensitive to other members of these classes of compounds. In response, various methods for countering such resistance when it occurs, or for reducing the likelihood of such resistance even developing, have been developed to enable continued use of synthetic fungicidal compounds when possible. These methods, also called “resistance management strategies”, include, among other steps, the simultaneous or sequential use of combinations of synthetic antifungal compounds that have different modes of action, limiting the number of uses of a particular antifungal compound during a giving growing season, and applying a given antifungal at a dosage that equals or exceed a particular minimum dosage. See, e.g. Keith J. Brent and Derek W. Hollomon, “Fungicide Resistance in Crop Pathogens: How Can it Be Managed?”, 2^{nd}, revised edition, 2007, Fungicide Resistance Action Committee (FRAC), Croplife International, Avenue Louise 143, 1050 Brussels, Belgium, available online at http://www.frac.info/frac/publication/anhang/FRAC_Mono1_{—}2007_{—}100 dpi.pdf.

In addition to combining fungicides (by simultaneous or alternating administration) in order to delay or reduce the emergence of resistant strains, fungicides are also often combined in mixtures in order to widen the spectrum and extend the duration of antifungal activity; and to exploit synergistic interaction between the active fungicidal compounds, whereby the overall activity can be increased. Synergy, which is a frequent phenomenon in fungicide mixtures, may occur between antifungal compounds of different natures and sources, between fungicides with different or identical modes of action, and between those prepared in different formulations.

While in principle combinations of synthetic antifungal compounds could be used to reduce the chemical load of any particular synthetic antifungal compound applied to crops, the fear of resistance at such lower loads has mitigated against the use of such lower loads, as reflected in the FRAC paper referenced above.

The fungal infections known generally as “rusts” are caused by fungi belonging to the phylum Basidiomycota; most of these are of the class Pucciniomycetes, order Pucciniales. Among those infections that adversely affect crops are common rust in corn, caused by Puccinia sorghi; Cedar-apple rust, caused by Gymnosporangium juniperi-virginianae; Coffee rust, caused by Hemileia vastatrix; Stem rust of wheat and Kentucky bluegrass, caused by Puccinia graminis; Soybean Rust, also known as Asian Soybean Rust, which can be caused by either Phakopsora meibomiae or P. pachyrhizi; Crown Rust of Oats and Ryegrass, caused by Puccinia coronata; Bean rust, caused by Uromyces phaseoli; Wheat rust in grains, caused by Puccinia persistens subsp. triticina; rust in stone fruits (peaches, apricots, nectarines and plums), caused by Tranzschelia discolor; and “Yellow” and “Black” rusts in cereals, caused respectively by P. sriiformis and P. graminis. Other species that are know to be problematic are Mycena citricolor (which infects coffee plants), Cronartium ribicola (White pine blister rust), Puccinia hemerocallidis (Daylily rust), and Uromyces appendeculatus (which infects beans).

Because many of the fungi that cause rust infections have a life cycle that requires two types of plants to reproduce, it is known that such fungi may be controlled, at least in part, by controlling the population of the second plant; such an approach may be attractive if the second plant is not a commercially valuable crop. Nevertheless, even in such cases, the use of fungicides can be helpful in controlling infection; and in cases of fungi in which reproduction requires only a single type of plant to reproduce, fungicides are an important means of controlling infection. Thus, for example, the prophylactic use of chlorothalonil (a chloronitrile having multi-site contact activity) or strobilurins (such as azoxystrobin, pyraclostrobin or trifloxystrobin, all of which are quinone outside inhibitors) against Soybean Rust, and the curative use of triazole fungicides (such as difenoconazole, cyproconazole, flusilazole, flutriafol, metconazole, myclobutanil, propiconazole, tebuconazole and tetraconazole, all of which are demethylation inhibitors that inhibit sterol biosynthesis) against Soybean rust, are known. The use of copper or copper oxide in combination with synthetic fungicides to treat Mycena citricolor has also been reported.

Similarly, other crop diseases caused by members of the group Basidiomycota may be treated using synthetic fungicidal compounds, but here too the development of resistance is a concern.

Emulsions containing tea tree oil (TTO) for fungicidal application to plants, e.g. to plant leaves, are known. See, for example, US Patent Publication No. 2007/0237837, and the commercial product available under the name Timorex Gold from Biomor Israel Ltd., P.O. Box 81, Qatzrin 12900 Israel, http://www.biomor.com/timorex%20gold.htm. Timorex Gold has been successfully applied to combat several rusts, although neither TTO in general nor Timorex Gold in particular appear in the FRAC literature among the fungicides used to treat rusts or other diseases causes by Basidiomycota.

### BRIEF DESCRIPTION OF EMBODIMENTS OF THE INVENTION

There is provided in accordance with an embodiment of the invention a method for treating a plant infection caused by a fungus of the group Basidiomycota, comprising applying to the plant a combination of tea tree oil (TTO) and a synthetic fungicidal compound. In some embodiments the fungal infection is caused by a member of class Pucciniomycetes. In some embodiments the fungal infection is caused by a member of the order Pucciniales. In some embodiments the fungal infection is a rust infection. In some embodiments the infection is selected from the group consisting of common rust in corn, caused by Puccinia sorghi; Cedar-apple rust, caused by Gymnosporangium juniperi-virginianae; Coffee rust, caused by Hemileia vastatrix; Stem rust of wheat and Kentucky bluegrass, caused by Puccinia graminis; Soybean Rust, also known as Asian Soybean Rust, which can be caused by either Phakopsora meibomiae or P. pachyrhizi; Crown Rust of Oats and Ryegrass, caused by Puccinia coronata; Bean rust, caused by Uromyces phaseoli; Wheat rust in grains, caused by Puccinia persistens subsp. triticina; and “Yellow” and “Black” rusts in cereals, caused respectively by P. sriiformis and P. graminis. In some embodiments the infection is rust in stone fruits (peaches, apricots, nectarines and plums), caused by Tranzschelia discolor. In some embodiments, infection is rust in onion and garlic plants, caused by Puccinia alli. In some embodiments, the infection is rust in beets, caused by Uromyces beta. In some embodiments, the infection is rust in fava bean plants, caused by Uromyces faba. In some embodiments, the infection is rust in rose plants, caused by Phragmidium mucronatum or Phragmidium tuberculatum. In some embodiments the infection is selected from the group consisting of Mycena citricolor (which infects coffee plants), Cronartium ribicola (White pine blister rust), Puccinia hemerocallidis (Daylily rust), and Uromyces appendeculatus (which infects beans). In some embodiments, the combination is applied to the leaves of the plant.

In some embodiments, the TTO is applied as a TTO-containing composition. In some embodiments, the TTO-containing composition comprises TTO and an emulsifier. In some embodiments the emulsifier is an ammonium or alkali metal salt of a C₆-C₂₆ fatty acid or a mixture of such salts. In some embodiments the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates. In some embodiments, the TTO-containing composition is an oil-in-water emulsion. In some embodiments, the TTO is present in the TTO-containing composition in an amount of from 0.01 wt. % to 10 wt. %. In some embodiments, the TTO is present in the TTO-containing composition in an amount of not more than 9 wt. %. In some embodiments, the TTO is present in the TTO-containing composition in an amount of not more than 8 wt. %. In some embodiments, the TTO is present in the TTO-containing composition in an amount of not more than 7 wt. %. In some embodiments, the TTO is present in the TTO-containing composition in an amount of not more than 6 wt. %. In some embodiments, the TTO is present in the TTO-containing composition in an amount of not more than 5 wt. %. In some embodiments, the TTO is present in the TTO-containing composition in an amount of not more than 4 wt. %. In some embodiments, the TTO is present in the TTO-containing composition in an amount of not more than 3 wt. %. In some embodiments, the TTO is present in the TTO-containing composition in an amount of not more than 2 wt. %. In some embodiments, the TTO is present in the TTO-containing composition in an amount of not more than 1 wt. %. In some embodiments, the TTO is present in the TTO-containing composition in an amount of at least 0.02 wt. %. In some embodiments, the TTO is present in the TTO-containing composition in an amount of at least 0.03 wt. %. In some embodiments, the TTO is present in the TTO-containing composition in an amount of at least 0.04 wt. %. In some embodiments, the TTO is present in the TTO-containing composition in an amount of at least 0.05 wt. %. In some embodiments, the TTO is present in the TTO-containing composition in an amount of at least 0.06 wt. %. In some embodiments, the TTO is present in the TTO-containing composition in an amount of at least 0.07 wt. %. In some embodiments, the TTO is present in the TTO-containing composition in an amount of at least 0.08 wt. %. In some embodiments, the TTO is present in the TTO-containing composition in an amount of at least 0.09 wt. %. In some embodiments, the TTO is present in the TTO-containing composition in an amount of at least 0.1 wt. %. In some embodiments, the TTO is present in the TTO-containing composition in an amount of at least 0.2 wt. %. In some embodiments, the TTO is present in the TTO-containing composition in an amount of at least 0.3 wt. %. In some embodiments, the TTO is present in the TTO-containing composition in an amount of at least 0.4 wt. %. In some embodiments, the TTO is present in the TTO-containing composition in an amount of at least 0.5 wt. %. In some embodiments, the TTO is present in the TTO-containing composition in an amount of at least 0.6 wt. %. In some embodiments, the TTO is present in the TTO-containing composition in an amount of at least 0.7 wt. %. In some embodiments, the TTO is present in the TTO-containing composition in an amount of at least 0.8 wt. %. In some embodiments, the TTO is present in the TTO-containing composition in an amount of at least 0.9 wt. %. In some embodiments, the TTO is present in the TTO-containing composition in an amount of at least 1.0 wt. %.

In some embodiments, the TTO-containing composition further comprises an additional etheric oil. In some embodiments, the additional etheric oil is selected from the group consisting of lavender (Lavandula angustifolia) oil, pine (Pinus sylvestris) oil, manuka (Leptosperemum scoparium) oil, kanuca (Kunzea ericoids) oil, eucalyptus (Eucaluptus globules) oil, bergamot (Citrus bergamia) oil, clove (Eugenia caryaphylata) oil, lemon (Citrus limoneum) oil, lemon grass (Cymbpogon citrates) oil, rosemary (Rosmarinus officialis) oil, geranium (Pelargonium graveoleus) oil, and mint oil, the latter of which refers to an etheric oil containing high levels of menthol and/or methane; and mixtures thereof.

In some embodiments, the TTO-containing composition further comprises the synthetic fungicidal compound. In some embodiments, the combination of TTO and synthetic fungicidal compound is applied simultaneously. In some embodiments, the combination of TTO and synthetic fungicidal compound is applied as a single mixture. In some embodiments, the combination of TTO and synthetic fungicidal compound is applied sequentially. In some embodiments, the combination of TTO and synthetic fungicidal compound is applied as separate compositions. In some embodiments, the application of the separate compositions is conducted at roughly the same time, e.g. the applications are conducted within a few minutes of each other. In some embodiments, the application of the separate compositions is conducted at different times, e.g. e.g. the applications are conducted at least a few days apart from each other. In some embodiments, the combination of TTO and synthetic fungicidal compound is applied in conjunction with at least one of a mineral oil and an emulsifier.

In some embodiments, the synthetic fungicidal compound is applied at a dosage rate that is less than the rate indicated by the manufacturer as being the correct dosage rate in the absence of TTO. In some embodiments, the dosage rate at which the synthetic fungicidal compound is applied is not greater than 95% of the correct dosage rate as indicated by the manufacturer in the absence of TTO. In some embodiments, the dosage rate at which the synthetic fungicidal compound is applied is not greater than 90% of the correct dosage rate as indicated by the manufacturer in the absence of TTO. In some embodiments, the dosage rate at which the synthetic fungicidal compound is applied is not greater than 85% of the correct dosage rate as indicated by the manufacturer in the absence of TTO. In some embodiments, the dosage rate at which the synthetic fungicidal compound is applied is not greater than 80% of the correct dosage rate as indicated by the manufacturer in the absence of TTO. In some embodiments, the dosage rate at which the synthetic fungicidal compound is applied is not greater than 75% of the correct dosage rate as indicated by the manufacturer in the absence of TTO. In some embodiments, the dosage rate at which the synthetic fungicidal compound is applied is not greater than 70% of the correct dosage rate as indicated by the manufacturer in the absence of TTO. In some embodiments, the dosage rate at which the synthetic fungicidal compound is applied is not greater than 65% of the correct dosage rate as indicated by the manufacturer in the absence of TTO. In some embodiments, the dosage rate at which the synthetic fungicidal compound is applied is not greater than 60% of the correct dosage rate as indicated by the manufacturer in the absence of TTO. In some embodiments, the dosage rate at which the synthetic fungicidal compound is applied is not greater than 55% of the correct dosage rate as indicated by the manufacturer in the absence of TTO. In some embodiments, the dosage rate at which the synthetic fungicidal compound is applied is not greater than 50% of the correct dosage rate as indicated by the manufacturer in the absence of TTO. In some embodiments, the dosage rate at which the synthetic fungicidal compound is applied is not greater than 45% of the correct dosage rate as indicated by the manufacturer in the absence of TTO. In some embodiments, the dosage rate at which the synthetic fungicidal compound is applied is not greater than 40% of the correct dosage rate as indicated by the manufacturer in the absence of TTO. In some embodiments, the dosage rate at which the synthetic fungicidal compound is applied is not greater than 35% of the correct dosage rate as indicated by the manufacturer in the absence of TTO. In some embodiments, the dosage rate at which the synthetic fungicidal compound is applied is not greater than 30% of the correct dosage rate as indicated by the manufacturer in the absence of TTO. In some embodiments, the dosage rate at which the synthetic fungicidal compound is applied is at least 40% of the correct dosage rate as indicated by the manufacturer in the absence of TTO. In some embodiments, the dosage rate at which the synthetic fungicidal compound is applied is at least 45% of the correct dosage rate as indicated by the manufacturer in the absence of TTO. In some embodiments, the dosage rate at which the synthetic fungicidal compound is applied is at least 50% of the correct dosage rate as indicated by the manufacturer in the absence of TTO. In some embodiments, the dosage rate at which the synthetic fungicidal compound is applied is at least 55% of the correct dosage rate as indicated by the manufacturer in the absence of TTO. In some embodiments, the dosage rate at which the synthetic fungicidal compound is applied is at least 60% of the correct dosage rate as indicated by the manufacturer in the absence of TTO. In some embodiments, the dosage rate at which the synthetic fungicidal compound is applied is at least 65% of the correct dosage rate as indicated by the manufacturer in the absence of TTO. In some embodiments, the dosage rate at which the synthetic fungicidal compound is applied is at least 70% of the correct dosage rate as indicated by the manufacturer in the absence of TTO. In some embodiments, the dosage rate at which the synthetic fungicidal compound is applied is at least 75% of the correct dosage rate as indicated by the manufacturer in the absence of TTO.

In some embodiments, the TTO is applied at a dosage rate that is less than the rate indicated by the manufacturer as the rate used when the TTO is applied in the absence of a synthetic fungicidal compound. In some embodiments, the dosage rate at which the TTO is applied is not greater than 95% of the correct dosage rate as indicated by the manufacturer in the absence of application of a synthetic fungicidal compound. In some embodiments, the dosage rate at which the TTO is applied is not greater than 90% of the correct dosage rate as indicated by the manufacturer in the absence of application of a synthetic fungicidal compound. In some embodiments, the dosage rate at which the TTO is applied is not greater than 85% of the correct dosage rate as indicated by the manufacturer in the absence of application of a synthetic fungicidal compound. In some embodiments, the dosage rate at which the TTO is applied is not greater than 80% of the correct dosage rate as indicated by the manufacturer in the absence of application of a synthetic fungicidal compound. In some embodiments, the dosage rate at which the TTO is applied is not greater than 75% of the correct dosage rate as indicated by the manufacturer in the absence of application of a synthetic fungicidal compound. In some embodiments, the dosage rate at which the TTO is applied is not greater than 70% of the correct dosage rate as indicated by the manufacturer in the absence of application of a synthetic fungicidal compound. In some embodiments, the dosage rate at which the TTO is applied is not greater than 65% of the correct dosage rate as indicated by the manufacturer in the absence of application of a synthetic fungicidal compound. In some embodiments, the dosage rate at which the TTO is applied is not greater than 60% of the correct dosage rate as indicated by the manufacturer in the absence of application of a synthetic fungicidal compound. In some embodiments, the dosage rate at which the TTO is applied is not greater than 55% of the correct dosage rate as indicated by the manufacturer in the absence of application of a synthetic fungicidal compound. In some embodiments, the dosage rate at which the TTO is applied is not greater than 50% of the correct dosage rate as indicated by the manufacturer in the absence of application of a synthetic fungicidal compound. In some embodiments, the dosage rate at which the TTO is applied is not greater than 45% of the correct dosage rate as indicated by the manufacturer in the absence of application of a synthetic fungicidal compound. In some embodiments, the dosage rate at which the TTO is applied is not greater than 40% of the correct dosage rate as indicated by the manufacturer in the absence of application of a synthetic fungicidal compound. In some embodiments, the TTO is applied is not greater than 35% of the correct dosage rate as indicated by the manufacturer in the absence of application of a synthetic fungicidal compound. In some embodiments, the dosage rate at which the TTO is applied is not greater than 30% of the correct dosage rate as indicated by the manufacturer in the absence of application of a synthetic fungicidal compound. In some embodiments, the dosage rate at which the TTO is applied is at least 40% of the correct dosage rate as indicated by the manufacturer in the absence of application of a synthetic fungicidal compound. In some embodiments, the dosage rate at which the TTO is applied is at least 45% of the correct dosage rate as indicated by the manufacturer in the absence of application of a synthetic fungicidal compound. In some embodiments, the dosage rate at which the TTO is applied is at least 50% of the correct dosage rate as indicated by the manufacturer in the absence of application of a synthetic fungicidal compound. In some embodiments, the dosage rate at which the TTO is applied is at least 55% of the correct dosage rate as indicated by the manufacturer in the absence of application of a synthetic fungicidal compound. In some embodiments, the dosage rate at which the TTO is applied is at least 60% of the correct dosage rate as indicated by the manufacturer in the absence of application of a synthetic fungicidal compound. In some embodiments, the dosage rate at which the TTO is applied is at least 65% of the correct dosage rate as indicated by the manufacturer in the absence of application of a synthetic fungicidal compound. In some embodiments, the dosage rate at which the TTO is applied is at least 70% of the correct dosage rate as indicated by the manufacturer in the absence of application of a synthetic fungicidal compound. In some embodiments, the dosage rate at which the TTOcomposition is applied is at least 75% of the correct dosage rate as indicated by the manufacturer in the absence of application of a synthetic fungicidal compound.

In some embodiments, the synthetic fungicidal compound is selected from the group consisting of demethylation inhibitors (DMIs), Amines, Quinone outside Inhibitors (QoIs), Anilinopyrimidines (APs), Benzimidazoles, Carboxamides, Dithiocarbamates, Morpholines, and copper or a salt thereof.

In some embodiments, the fungicidal compound is a demethylation inhibitor (DMI) selected from the group consisting of difenoconazole, cyproconazole, flusilazole, flutriafol, metconazole, myclobutanil, propiconazole, tebuconazole and tetraconazole. In some embodiments the DMI is selected from the group consisting of myclobutanil, propiconazole and tetraconazole. In some embodiments, the fungicidal compound is a DMI other than difenoconazole, cyproconazole, flusilazole, flutriafol, metconazole, myclobutanil, propiconazole, tebuconazole and tetraconazole. In some embodiments the DMI is selected from the group consisting of azaconazole, bitertanol, bromuconazole, diniconazole, epoxiconazole, etaconazole, fenbuconazole, fluquinconazole, hexaconazole, imibenconazole, ipconazole, penconazole, prothioconazole, simeconazole, triadimefon, triadimenol and triticonazole. In some embodiments, the DMI is selected from triforine, pyrifenox, pyrisoxazole, fenarimol, nuarimol, imazalil, oxpoconazole, pefurazoate, prochloraz, and triflumizole. In some embodiments, the synthetic fungicidal compound is an amine fungicidal compound selected from the group consisting of spiroxamine, fenpropimorph and tridemorph. In some embodiments, the synthetic fungicidal compound is a QoI fungicidal compound selected from the group consisting of azoxystrobin, pyraclostrobin, kesoxym-methyl, picoxystrobin, pyrmetostrobin and trifloxystrobin. In some embodiments the synthetic fungicidal compound is selected from the group consisting of azoxystrobin and pyraclostrobin. In some embodiments, the synthetic fungicidal compound is a strobilurin other than azoxystrobin, pyraclostrobin, kesoxym-methyl, picoxystrobin, pyrmetostrobin and trifloxystrobin. In some embodiments the synthetic fungicidal compound is a QoI selected from the group consisting of azoxystrobin, coumoxystrobin, enoxastrobin, flufenoxystrobin, picoxystrobin, pyraoxystrobin, pyraclostrobin, pyrametostrobin, triclopyricarb, kresoxim-methyl, trifloxystrobin, dimoxystrobin, fenaminostrobin, metominostrobin, orysastrobin, famoxadone, fluoxastrobin, fenamidone and pyribencarb.

In some embodiments, the synthetic fungicidal compound is pyrimethanil. In some embodiments, the synthetic fungicidal compound is a benzimidazole selected from the group consisting of benomyl, carbendazim, thiabendazole, thiophanate and thiophanate-methyl. In some embodiments the synthetic fungicidal compound is the dithiocarbamate mancozeb.

In some embodiments, the synthetic fungicidal compound is chlorothalonil. In some embodiments, the synthetic fungicidal compound is copper or a copper salt.

In some embodiments, the synthetic fungicidal compound is a compound that is indicated for the treatment of common rust in corn, and the combination is applied to at least one corn plant. In some embodiments, the synthetic fungicidal compound is a compound that is indicated for the treatment of Cedar-apple rust, and the combination is applied to at least one apple plant. In some embodiments, the synthetic fungicidal compound is a compound that is indicated for the treatment of coffee rust, and the combination is applied to at least one coffee plant. In some embodiments, the synthetic fungicidal compound is a compound that is indicated for the treatment of stem rust of wheat, and the combination is applied to at least one wheat plant. In some embodiments, the synthetic fungicidal compound is a compound that is indicated for the treatment of soybean rust, and the combination is applied to at least one soybean plant. In some embodiments, the synthetic fungicidal compound is a compound that is indicated for the treatment of Crown Rust of Oats and Ryegrass, and the combination is applied to at least one oat or ryegrass plant. In some embodiments, the synthetic fungicidal compound is a compound that is indicated for the treatment of wheat rust in grains, and the combination is applied to at least one grain-yielding plant. In some embodiments, the synthetic fungicidal compound is a compound that is indicated for the treatment of yellow or black rust in cereals, and the combination is applied to at least one cereal-yielding plant. In some embodiments, the synthetic fungicidal compound is a compound that is indicated for the treatment of an infection caused by Uromyces appendeculatus, and the combination is applied to at least one bean plant. In some embodiments, the synthetic fungicidal compound is a compound that is indicated for the treatment of rust in stone fruits (peaches, apricots, nectarines and plums), and the combination is applied to at least one stone fruit plant. In some embodiments, the synthetic fungicidal compound is a compound that is indicated for the treatment of rust in onion and garlic plants, and the combination is applied to at least one onion or garlic plant. In some embodiments, the synthetic fungicidal compound is a compound that is indicated for the treatment of rust in beets, and the combination is applied to at least one beet plant. In some embodiments, the synthetic fungicidal compound is a compound that is indicated for the treatment of rust in fava bean plants, and the combination is applied to at least fava bean plant. In some embodiments, the synthetic fungicidal compound is a compound that is indicated for the treatment of rust in rose plants, and the combination is applied to at least rose plant.

In some embodiments, the synthetic fungicidal compound is selected from the group consisting of mancozeb, chlorothalonil, trifloxystrobin, krsoxim-methyl, orysastrobin, fluoxastrobin, azoxystrobin, pyraclostrobin, dimoxystrobin, picoxystrobin, carbendazim, thiophanate-methyl, thiophanate, thiabendazole, benomyl, boscalid, penthiopyrad, thifluzamide, bixafen, fluopyram, isopyrazam, fenpropimorph, fenpropidin, fenarimol, triforine, spiroxamine, tridemorph, elemental sulfur, quinoxyfen, meptyl dinocap, bupirimate, proquinazid, metrafenone, cyflufenamid, tebuconazole, epoxiconazole, propiconazole, prothioconazole, cyproconazole, difenoconazole, metconazole, flusilazole, myclobutanil, flutriafol, triadimefon, penconazole, bitertanol, hexaconazole, triadimenol, tetraconazole, fluquinconazole, triticonazole, fenbuconazole, diniconazole, bromuconazole, ipconazole, simeconazole, imibenconazole, azaconazole, etaconazole and diclobutrazol.

In some embodiments, the treatment is prophylactic treatment. In some embodiments, the treatment is curative.

There are also provided, in accordance with embodiments of the invention, (1) a method for reducing the dosage rate of a synthetic compound that has fungicidal activity against a plant-infection causing fungus of the group Basidiomycota, comprising applying to a plant having such an infection which has been treated with such a synthetic fungicidal compound a tea tree oil (TTO)-containing composition; and (2) a method for reducing the dosage rate of a TTO-containing composition, comprising applying to a plant having an infection caused by a fungus of the group Basidiomycota which has been treated with a TTO-containing composition a synthetic fungicidal compound.

In some embodiments the fungal infection is caused by a member of the class Pucciniomycetes. In some embodiments the fungal infection is caused by a member of the order Pucciniales. In some embodiments the fungal infection is a rust infection. In some embodiments the infection is selected from the group consisting of common rust in corn, caused by Puccinia sorghi; Cedar-apple rust, caused by Gymnosporangium juniperi-virginianae; Coffee rust, caused by Hemileia vastatrix; Stem rust of wheat and Kentucky bluegrass, caused by Puccinia graminis; Soybean Rust, also known as Asian Soybean Rust, which can be caused by either Phakopsora meibomiae or P. pachyrhizi; Crown Rust of Oats and Ryegrass, caused by Puccinia coronata; Bean rust, caused by Uromyces phaseoli; Wheat rust in grains, caused by Puccinia persistens subsp. triticina; and “Yellow” and “Black” rusts in cereals, caused respectively by P. sriiformis and P. graminis. In some embodiments the infection is selected from the group consisting of Mycena citricolor (which infects coffee plants), Cronartium ribicola (White pine blister rust), Puccinia hemerocallidis (Daylily rust), and Uromyces appendeculatus (which infects beans). In some embodiments the infection is rust in stone fruits (peaches, apricots, nectarines and plums), caused by Tranzschelia discolor. In some embodiments, infection is rust in onion and garlic plants, caused by Puccinia alli. In some embodiments, the infection is rust in beets, caused by Uromyces beta. In some embodiments, the infection is rust in fava bean plants, caused by Uromyces faba. In some embodiments, the infection is rust in rose plants, caused by Phragmidium mucronatum or Phragmidium tuberculatum. In some embodiments the infection is selected from the group consisting of Mycena citricolor (which infects coffee plants), Cronartium ribicola (White pine blister rust), Puccinia hemerocallidis (Daylily rust), and Uromyces appendeculatus (which infects beans). In some embodiments, the composition is applied to the leaves of the plant.

In some embodiments, the TTO-containing composition comprises TTO and an emulsifier. In some embodiments the emulsifier is an ammonium or alkali metal salt of a C₆-C₂₆ fatty acid or a mixture of such salts. In some embodiments the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates. In some embodiments, the TTO-containing composition is an oil-in-water emulsion. In some embodiments, the TTO is present in the TTO-containing composition in an amount of from 0.01 wt. % to 10 wt. %. In some embodiments, the TTO is present in the TTO-containing composition in an amount of not more than 9 wt. %. In some embodiments, the TTO is present in the TTO-containing composition in an amount of not more than 8 wt. %. In some embodiments, the TTO is present in the TTO-containing composition in an amount of not more than 7 wt. %. In some embodiments, the TTO is present in the TTO-containing composition in an amount of not more than 6 wt. %. In some embodiments, the TTO is present in the TTO-containing composition in an amount of not more than 5 wt. %. In some embodiments, the TTO is present in the TTO-containing composition in an amount of not more than 4 wt. %. In some embodiments, the TTO is present in the TTO-containing composition in an amount of not more than 3 wt. %. In some embodiments, the TTO is present in the TTO-containing composition in an amount of not more than 2 wt. %. In some embodiments, the TTO is present in the TTO-containing composition in an amount of not more than 1 wt. %. In some embodiments, the TTO is present in the TTO-containing composition in an amount of at least 0.02 wt. %. In some embodiments, the TTO is present in the TTO-containing composition in an amount of at least 0.03 wt. %. In some embodiments, the TTO is present in the TTO-containing composition in an amount of at least 0.04 wt. %. In some embodiments, the TTO is present in the TTO-containing composition in an amount of at least 0.05 wt. %. In some embodiments, the TTO is present in the TTO-containing composition in an amount of at least 0.06 wt. %. In some embodiments, the TTO is present in the TTO-containing composition in an amount of at least 0.07 wt. %. In some embodiments, the TTO is present in the TTO-containing composition in an amount of at least 0.08 wt. %. In some embodiments, the TTO is present in the TTO-containing composition in an amount of at least 0.09 wt. %. In some embodiments, the TTO is present in the TTO-containing composition in an amount of at least 0.1 wt. %. In some embodiments, the TTO is present in the TTO-containing composition in an amount of at least 0.2 wt. %. In some embodiments, the TTO is present in the TTO-containing composition in an amount of at least 0.3 wt. %. In some embodiments, the TTO is present in the TTO-containing composition in an amount of at least 0.4 wt. %. In some embodiments, the TTO is present in the TTO-containing composition in an amount of at least 0.5 wt. %. In some embodiments, the TTO is present in the TTO-containing composition in an amount of at least 0.6 wt. %. In some embodiments, the TTO is present in the TTO-containing composition in an amount of at least 0.7 wt. %. In some embodiments, the TTO is present in the TTO-containing composition in an amount of at least 0.8 wt. %. In some embodiments, the TTO is present in the TTO-containing composition in an amount of at least 0.9 wt. %. In some embodiments, the TTO is present in the TTO-containing composition in an amount of at least 1.0 wt. %.

In some embodiments, the TTO-containing composition further comprises an additional etheric oil. In some embodiments, the additional etheric oil is selected from the group consisting of lavender (Lavandula angustifolia) oil, pine (Pinus sylvestris) oil, manuka (Leptosperemum scoparium) oil, kanuca (Kunzea ericoids) oil, eucalyptus (Eucaluptus globules) oil, bergamot (Citrus bergamia) oil, clove (Eugenia caryaphylata) oil, lemon (Citrus limoneum) oil, lemon grass (Cymbpogon citrates) oil, rosemary (Rosmarinus officialis) oil, geranium (Pelargonium graveoleus) oil, and mint oil, the latter of which refers to an etheric oil containing high levels of menthol and/or methane; and mixtures thereof.

In some embodiments, the TTO-containing composition further comprises the synthetic fungicidal compound. In some embodiments, the combination of TTO and synthetic fungicidal compound is applied simultaneously. In some embodiments, the combination of TTO and synthetic fungicidal compound is applied as a single mixture. In some embodiments, the combination of TTO and synthetic fungicidal compound is applied sequentially. In some embodiments, the combination of TTO and synthetic fungicidal compound is applied as separate compositions. In some embodiments, the combination of TTO and synthetic fungicidal compound is applied in conjunction with at least one of a mineral oil and an emulsifier.

In some embodiments, the synthetic fungicidal compound is applied at a dosage rate that is less than the rate indicated by the manufacturer as being the correct dosage rate in the absence of TTO. In some embodiments, the dosage rate at which the synthetic fungicidal compound is applied is not greater than 95% of the correct dosage rate as indicated by the manufacturer in the absence of TTO. In some embodiments, the dosage rate at which the synthetic fungicidal compound is applied is not greater than 90% of the correct dosage rate as indicated by the manufacturer in the absence of TTO. In some embodiments, the dosage rate at which the synthetic fungicidal compound is applied is not greater than 85% of the correct dosage rate as indicated by the manufacturer in the absence of TTO. In some embodiments, the dosage rate at which the synthetic fungicidal compound is applied is not greater than 80% of the correct dosage rate as indicated by the manufacturer in the absence of TTO. In some embodiments, the dosage rate at which the synthetic fungicidal compound is applied is not greater than 75% of the correct dosage rate as indicated by the manufacturer in the absence of TTO. In some embodiments, the dosage rate at which the synthetic fungicidal compound is applied is not greater than 70% of the correct dosage rate as indicated by the manufacturer in the absence of TTO. In some embodiments, the dosage rate at which the synthetic fungicidal compound is applied is not greater than 65% of the correct dosage rate as indicated by the manufacturer in the absence of TTO. In some embodiments, the dosage rate at which the synthetic fungicidal compound is applied is not greater than 60% of the correct dosage rate as indicated by the manufacturer in the absence of TTO. In some embodiments, the dosage rate at which the synthetic fungicidal compound is applied is not greater than 55% of the correct dosage rate as indicated by the manufacturer in the absence of TTO. In some embodiments, the dosage rate at which the synthetic fungicidal compound is applied is not greater than 50% of the correct dosage rate as indicated by the manufacturer in the absence of TTO. In some embodiments, the dosage rate at which the synthetic fungicidal compound is applied is not greater than 45% of the correct dosage rate as indicated by the manufacturer in the absence of TTO. In some embodiments, the dosage rate at which the synthetic fungicidal compound is applied is not greater than 40% of the correct dosage rate as indicated by the manufacturer in the absence of TTO. In some embodiments, the dosage rate at which the synthetic fungicidal compound is applied is not greater than 35% of the correct dosage rate as indicated by the manufacturer in the absence of TTO. In some embodiments, the dosage rate at which the synthetic fungicidal compound is applied is not greater than 30% of the correct dosage rate as indicated by the manufacturer in the absence of TTO. In some embodiments, the dosage rate at which the synthetic fungicidal compound is applied is at least 40% of the correct dosage rate as indicated by the manufacturer in the absence of TTO. In some embodiments, the dosage rate at which the synthetic fungicidal compound is applied is at least 45% of the correct dosage rate as indicated by the manufacturer in the absence of TTO. In some embodiments, the dosage rate at which the synthetic fungicidal compound is applied is at least 50% of the correct dosage rate as indicated by the manufacturer in the absence of TTO. In some embodiments, the dosage rate at which the synthetic fungicidal compound is applied is at least 55% of the correct dosage rate as indicated by the manufacturer in the absence of TTO. In some embodiments, the dosage rate at which the synthetic fungicidal compound is applied is at least 60% of the correct dosage rate as indicated by the manufacturer in the absence of TTO. In some embodiments, the dosage rate at which the synthetic fungicidal compound is applied is at least 65% of the correct dosage rate as indicated by the manufacturer in the absence of TTO. In some embodiments, the dosage rate at which the synthetic fungicidal compound is applied is at least 70% of the correct dosage rate as indicated by the manufacturer in the absence of TTO. In some embodiments, the dosage rate at which the synthetic fungicidal compound is applied is at least 75% of the correct dosage rate as indicated by the manufacturer in the absence of TTO.

In some embodiments, the TTO-containing composition is applied at a dosage rate that is less than the rate indicated by the manufacturer as the rate used when the TTO-containing composition is applied in the absence of a synthetic fungicidal compound. In some embodiments, the dosage rate at which the TTO-containing composition is applied is not greater than 95% of the correct dosage rate as indicated by the manufacturer in the absence of application of a synthetic fungicidal compound. In some embodiments, the dosage rate at which the TTO-containing composition is applied is not greater than 90% of the correct dosage rate as indicated by the manufacturer in the absence of application of a synthetic fungicidal compound. In some embodiments, the dosage rate at which the TTO-containing composition is applied is not greater than 85% of the correct dosage rate as indicated by the manufacturer in the absence of application of a synthetic fungicidal compound. In some embodiments, the dosage rate at which the TTO-containing composition is applied is not greater than 80% of the correct dosage rate as indicated by the manufacturer in the absence of application of a synthetic fungicidal compound. In some embodiments, the dosage rate at which the TTO-containing composition is applied is not greater than 75% of the correct dosage rate as indicated by the manufacturer in the absence of application of a synthetic fungicidal compound. In some embodiments, the dosage rate at which the TTO-containing composition is applied is not greater than 70% of the correct dosage rate as indicated by the manufacturer in the absence of application of a synthetic fungicidal compound. In some embodiments, the dosage rate at which the TTO-containing composition is applied is not greater than 65% of the correct dosage rate as indicated by the manufacturer in the absence of application of a synthetic fungicidal compound. In some embodiments, the dosage rate at which the TTO-containing composition is applied is not greater than 60% of the correct dosage rate as indicated by the manufacturer in the absence of application of a synthetic fungicidal compound. In some embodiments, the dosage rate at which the TTO-containing composition is applied is not greater than 55% of the correct dosage rate as indicated by the manufacturer in the absence of application of a synthetic fungicidal compound. In some embodiments, the dosage rate at which the TTO-containing composition is applied is not greater than 50% of the correct dosage rate as indicated by the manufacturer in the absence of application of a synthetic fungicidal compound. In some embodiments, the dosage rate at which the TTO-containing composition is applied is not greater than 45% of the correct dosage rate as indicated by the manufacturer in the absence of application of a synthetic fungicidal compound. In some embodiments, the dosage rate at which the TTO-containing composition is applied is not greater than 40% of the correct dosage rate as indicated by the manufacturer in the absence of application of a synthetic fungicidal compound. In some embodiments, the TTO-containing composition is applied is not greater than 35% of the correct dosage rate as indicated by the manufacturer in the absence of application of a synthetic fungicidal compound. In some embodiments, the dosage rate at which the TTO-containing composition is applied is not greater than 30% of the correct dosage rate as indicated by the manufacturer in the absence of application of a synthetic fungicidal compound. In some embodiments, the dosage rate at which the TTO-containing composition is applied is at least 40% of the correct dosage rate as indicated by the manufacturer in the absence of application of a synthetic fungicidal compound. In some embodiments, the dosage rate at which the TTO-containing composition is applied is at least 45% of the correct dosage rate as indicated by the manufacturer in the absence of application of a synthetic fungicidal compound. In some embodiments, the dosage rate at which the TTO-containing composition is applied is at least 50% of the correct dosage rate as indicated by the manufacturer in the absence of application of a synthetic fungicidal compound. In some embodiments, the dosage rate at which the TTO-containing composition is applied is at least 55% of the correct dosage rate as indicated by the manufacturer in the absence of application of a synthetic fungicidal compound. In some embodiments, the dosage rate at which the TTO-containing composition is applied is at least 60% of the correct dosage rate as indicated by the manufacturer in the absence of application of a synthetic fungicidal compound. In some embodiments, the dosage rate at which the TTO-containing composition is applied is at least 65% of the correct dosage rate as indicated by the manufacturer in the absence of application of a synthetic fungicidal compound. In some embodiments, the dosage rate at which the TTO-containing composition is applied is at least 70% of the correct dosage rate as indicated by the manufacturer in the absence of application of a synthetic fungicidal compound. In some embodiments, the dosage rate at which the TTO-containing composition composition is applied is at least 75% of the correct dosage rate as indicated by the manufacturer in the absence of application of a synthetic fungicidal compound.

In some embodiments, the synthetic fungicidal compound is selected from the group consisting of demethylation inhibitors (DMIs), Amines, Quinone outside Inhibitors (QoIs), Anilinopyrimidines (APs), and Benzimidazoles, Carboxamides, Dithiocarbamates, Morpholines, and copper or a salt thereof.

In some embodiments, the fungicidal compound is a demethylation inhibitor (DMI) selected from the group consisting of difenoconazole, cyproconazole, flusilazole, flutriafol, metconazole, myclobutanil, propiconazole, tebuconazole and tetraconazole. In some embodiments the DMI is selected from the group consisting of myclobutanil, propiconazole and tetraconazole. In some embodiments, the fungicidal compound is a DMI other than difenoconazole, cyproconazole, flusilazole, flutriafol, metconazole, myclobutanil, propiconazole, tebuconazole and tetraconazole. In some embodiments the DMI is selected from the group consisting of azaconazole, bitertanol, bromuconazole, diniconazole, epoxiconazole, etaconazole, fenbuconazole, fluquinconazole, hexaconazole, imibenconazole, ipconazole, penconazole, prothioconazole, simeconazole, triadimefon, triadimenol and triticonazole. In some embodiments, the DMI is selected from triforine, pyrifenox, pyrisoxazole, fenarimol, nuarimol, imazalil, oxpoconazole, pefurazoate, prochloraz, and triflumizole. In some embodiments, the synthetic fungicidal compound is an amine fungicidal compound selected from the group consisting of spiroxamine, fenpropimorph and tridemorph. In some embodiments, the synthetic fungicidal compound is a QoI fungicidal compound selected from the group consisting of azoxystrobin, pyraclostrobin, kesoxym-methyl, picoxystrobin, pyrmetostrobin and trifloxystrobin. In some embodiments the synthetic fungicidal compound is selected from the group consisting of azoxystrobin and pyraclostrobin. In some embodiments, the synthetic fungicidal compound is a strobilurin other than azoxystrobin, pyraclostrobin, kesoxym-methyl, picoxystrobin, pyrmetostrobin and trifloxystrobin. In some embodiments the synthetic fungicidal compound is a QoI selected from the group consisting of azoxystrobin, coumoxystrobin, enoxastrobin, flufenoxystrobin, picoxystrobin, pyraoxystrobin, pyraclostrobin, pyrametostrobin, triclopyricarb, kresoxim-methyl, trifloxystrobin, dimoxystrobin, fenaminostrobin, metominostrobin, orysastrobin, famoxadone, fluoxastrobin, fenamidone and pyribencarb.

In some embodiments, the synthetic fungicidal compound is pyrimethanil. In some embodiments, the synthetic fungicidal compound is a benzimidazole selected from the group consisting of benomyl, carbendazim, thiabendazole, thiophanate and thiophanate-methyl. In some embodiments the synthetic fungicidal compound is the dithiocarbamate mancozeb.

In some embodiments, the synthetic fungicidal compound is chlorothalonil. In some embodiments, the synthetic fungicidal compound is copper or a copper salt.

In some embodiments, the synthetic fungicidal compound is a compound that is indicated for the treatment of common rust in corn, and the combination is applied to at least one corn plant. In some embodiments, the synthetic fungicidal compound is a compound that is indicated for the treatment of Cedar-apple rust, and the combination is applied to at least one apple plant. In some embodiments, the synthetic fungicidal compound is a compound that is indicated for the treatment of coffee rust, and the combination is applied to at least one coffee plant. In some embodiments, the synthetic fungicidal compound is a compound that is indicated for the treatment of stem rust of wheat, and the combination is applied to at least one wheat plant. In some embodiments, the synthetic fungicidal compound is a compound that is indicated for the treatment of soybean rust, and the combination is applied to at least one soybean plant. In some embodiments, the synthetic fungicidal compound is a compound that is indicated for the treatment of Crown Rust of Oats and Ryegrass, and the combination is applied to at least one oat or ryegrass plant. In some embodiments, the synthetic fungicidal compound is a compound that is indicated for the treatment of wheat rust in grains, and the combination is applied to at least one grain-yielding plant. In some embodiments, the synthetic fungicidal compound is a compound that is indicated for the treatment of yellow or black rust in cereals, and the combination is applied to at least one cereal-yielding plant. In some embodiments, the synthetic fungicidal compound is a compound that is indicated for the treatment of an infection caused by Uromyces appendeculatus, and the combination is applied to at least one bean plant. In some embodiments, the synthetic fungicidal compound is a compound that is indicated for the treatment of rust in stone fruits (peaches, apricots, nectarines and plums), and the combination is applied to at least one stone fruit plant. In some embodiments, the synthetic fungicidal compound is a compound that is indicated for the treatment of rust in onion and garlic plants, and the combination is applied to at least one onion or garlic plant. In some embodiments, the synthetic fungicidal compound is a compound that is indicated for the treatment of rust in beets, and the combination is applied to at least one beet plant. In some embodiments, the synthetic fungicidal compound is a compound that is indicated for the treatment of rust in fava bean plants, and the combination is applied to at least fava bean plant. In some embodiments, the synthetic fungicidal compound is a compound that is indicated for the treatment of rust in rose plants, and the combination is applied to at least rose plant.

In some embodiments, the synthetic fungicidal compound is selected from the group consisting of mancozeb, chlorothalonil, trifloxystrobin, krsoxim-methyl, orysastrobin, fluoxastrobin, azoxystrobin, pyraclostrobin, dimoxystrobin, picoxystrobin, carbendazim, thiophanate-methyl, thiophanate, thiabendazole, benomyl, boscalid, penthiopyrad, thifluzamide, bixafen, fluopyram, isopyrazam, fenpropimorph, fenpropidin, fenarimol, triforine, spiroxamine, tridemorph, elemental sulfur, quinoxyfen, meptyl dinocap, bupirimate, proquinazid, metrafenone, cyflufenamid, tebuconazole, epoxiconazole, propiconazole, prothioconazole, cyproconazole, difenoconazole, metconazole, flusilazole, myclobutanil, flutriafol, triadimefon, penconazole, bitertanol, hexaconazole, triadimenol, tetraconazole, fluquinconazole, triticonazole, fenbuconazole, diniconazole, bromuconazole, ipconazole, simeconazole, imibenconazole, azaconazole, etaconazole and diclobutrazol.

In some embodiments, the treatment is prophylactic treatment. In some embodiments, the treatment is curative.

There is also provided, in accordance with an embodiment of the invention, a kit containing at least one of tea tree oil (TTO) and a synthetic fungicidal compound which is active against a fungus of the group Basidiomycota, and instructions that instruct the user how to treat a plant infection caused by a fungus of the group Basidiomycota by applying to the plant a combination of a TTO composition and a synthetic fungicidal compound. In some embodiments the fungal infection is caused by a member of the class Pucciniomycetes. In some embodiments the fungal infection is caused by a member of the order Pucciniales. In some embodiments, the kit contains TTO in a TTO-containing composition. In some embodiments, the kit contains a synthetic fungicidal compound which is active against a fungus of the group Basidiomycota. In some embodiments, the instructions instruct to apply the synthetic fungicidal compound at a dosage rate that is less than the rate indicated by the manufacturer as being the correct dosage rate in the absence of a TTO-containing composition. In some embodiments, the instructions instruct to apply the TTO at a dosage rate that is less than the rate indicated by the manufacturer of the TTO as being the correct dosage rate in the absence of a synthetic fungicidal composition. In some embodiments, the instructions instruct to apply the combination simultaneously. In some embodiments, the instructions instruct to apply the combination as a single mixture. In some embodiments, the instructions instruct to apply the combination sequentially. In some embodiments, the instructions instruct to apply the combination as separate compositions. In some embodiments, the instructions instruct to apply the combination in conjunction with at least one of a mineral oil and an emulsifier.

In some embodiments, the instructions instruct to apply the synthetic fungicidal compound at a dosage rate which is not greater than 95% of the correct dosage rate as indicated by the manufacturer in the absence of TTO. In some embodiments, the instructions instruct to apply the synthetic fungicidal compound at a dosage rate at which not greater than 90% of the correct dosage rate as indicated by the manufacturer in the absence of TTO. In some embodiments, the instructions instruct to apply the synthetic fungicidal compound at a dosage rate at which not greater than 85% of the correct dosage rate as indicated by the manufacturer in the absence of TTO. In some embodiments, the instructions instruct to apply the synthetic fungicidal compound at a dosage rate at which not greater than 80% of the correct dosage rate as indicated by the manufacturer in the absence of TTO. In some embodiments, the instructions instruct to apply the synthetic fungicidal compound at a dosage rate at which not greater than 75% of the correct dosage rate as indicated by the manufacturer in the absence of TTO. In some embodiments, the instructions instruct to apply the synthetic fungicidal compound at a dosage rate at which not greater than 70% of the correct dosage rate as indicated by the manufacturer in the absence of TTO. In some embodiments, the instructions instruct to apply the synthetic fungicidal compound at a dosage rate at which not greater than 65% of the correct dosage rate as indicated by the manufacturer in the absence of TTO. In some embodiments, the instructions instruct to apply the synthetic fungicidal compound at a dosage rate at which not greater than 60% of the correct dosage rate as indicated by the manufacturer in the absence of TTO. In some embodiments, the instructions instruct to apply the synthetic fungicidal compound at a dosage rate at which not greater than 55% of the correct dosage rate as indicated by the manufacturer in the absence of TTO. In some embodiments, the instructions instruct to apply the synthetic fungicidal compound at a dosage rate at which not greater than 50% of the correct dosage rate as indicated by the manufacturer in the absence of TTO. In some embodiments, the instructions instruct to apply the synthetic fungicidal compound at a dosage rate at which not greater than 45% of the correct dosage rate as indicated by the manufacturer in the absence of TTO. In some embodiments, the instructions instruct to apply the synthetic fungicidal compound at a dosage rate at which not greater than 40% of the correct dosage rate as indicated by the manufacturer in the absence of TTO. In some embodiments, the instructions instruct to apply the synthetic fungicidal compound at a dosage rate at which not greater than 35% of the correct dosage rate as indicated by the manufacturer in the absence of TTO. In some embodiments, the instructions instruct to apply the synthetic fungicidal compound at a dosage rate at which not greater than 30% of the correct dosage rate as indicated by the manufacturer in the absence of TTO. In some embodiments, the instructions instruct to apply the synthetic fungicidal compound at a dosage rate that is at least 40% of the correct dosage rate as indicated by the manufacturer in the absence of TTO. In some embodiments, the instructions instruct to apply the synthetic fungicidal compound at a dosage rate that is at least 45% of the correct dosage rate as indicated by the manufacturer in the absence of TTO. In some embodiments, the instructions instruct to apply the synthetic fungicidal compound at a dosage rate that is at least 50% of the correct dosage rate as indicated by the manufacturer in the absence of TTO. In some embodiments, the instructions instruct to apply the synthetic fungicidal compound at a dosage rate that is at least 55% of the correct dosage rate as indicated by the manufacturer in the absence of TTO. In some embodiments, the instructions instruct to apply the synthetic fungicidal compound at a dosage rate that is at least 60% of the correct dosage rate as indicated by the manufacturer in the absence of TTO. In some embodiments, the instructions instruct to apply the synthetic fungicidal compound at a dosage rate that is at least 65% of the correct dosage rate as indicated by the manufacturer in the absence of TTO. In some embodiments, the instructions instruct to apply the synthetic fungicidal compound at a dosage rate that is at least 70% of the correct dosage rate as indicated by the manufacturer in the absence of TTO. In some embodiments, the instructions instruct to apply the synthetic fungicidal compound at a dosage rate that is at least 75% of the correct dosage rate as indicated by the manufacturer in the absence of TTO.

In some embodiments, the instructions instruct to apply the TTO-containing composition at a dosage rate that is less than the rate indicated by the manufacturer as the rate used when the TTO-containing composition is applied in the absence of a synthetic fungicidal compound. In some embodiments, the instructions instruct to apply the TTO-containing composition at a dosage rate that is not greater than 95% of the correct dosage rate as indicated by the manufacturer in the absence of application of a synthetic fungicidal compound. In some embodiments, the instructions instruct to apply the TTO-containing composition at a dosage rate that is not greater than 90% of the correct dosage rate as indicated by the manufacturer in the absence of application of a synthetic fungicidal compound. In some embodiments, the instructions instruct to apply the TTO-containing composition at a dosage rate that is not greater than 85% of the correct dosage rate as indicated by the manufacturer in the absence of application of a synthetic fungicidal compound. In some embodiments, the instructions instruct to apply the TTO-containing composition at a dosage rate that is not greater than 80% of the correct dosage rate as indicated by the manufacturer in the absence of application of a synthetic fungicidal compound. In some embodiments, the instructions instruct to apply the TTO-containing composition at a dosage rate that is not greater than 75% of the correct dosage rate as indicated by the manufacturer in the absence of application of a synthetic fungicidal compound. In some embodiments, the instructions instruct to apply the TTO-containing composition at a dosage rate that is not greater than 70% of the correct dosage rate as indicated by the manufacturer in the absence of application of a synthetic fungicidal compound. In some embodiments, the instructions instruct to apply the TTO-containing composition at a dosage rate that is not greater than 65% of the correct dosage rate as indicated by the manufacturer in the absence of application of a synthetic fungicidal compound. In some embodiments, the instructions instruct to apply the TTO-containing composition at a dosage rate that is not greater than 60% of the correct dosage rate as indicated by the manufacturer in the absence of application of a synthetic fungicidal compound. In some embodiments, the instructions instruct to apply the TTO-containing composition at a dosage rate that is not greater than 55% of the correct dosage rate as indicated by the manufacturer in the absence of application of a synthetic fungicidal compound. In some embodiments, the instructions instruct to apply the TTO-containing composition at a dosage rate that is not greater than 50% of the correct dosage rate as indicated by the manufacturer in the absence of application of a synthetic fungicidal compound. In some embodiments, the instructions instruct to apply the TTO-containing composition at a dosage rate that is not greater than 45% of the correct dosage rate as indicated by the manufacturer in the absence of application of a synthetic fungicidal compound. In some embodiments, the instructions instruct to apply the TTO-containing composition at a dosage rate that is not greater than 40% of the correct dosage rate as indicated by the manufacturer in the absence of application of a synthetic fungicidal compound. In some embodiments, the instructions instruct to apply the TTO-containing composition at a dosage rate that is not greater than 35% of the correct dosage rate as indicated by the manufacturer in the absence of application of a synthetic fungicidal compound. In some embodiments, the instructions instruct to apply the TTO-containing composition at a dosage rate that is not greater than 30% of the correct dosage rate as indicated by the manufacturer in the absence of application of a synthetic fungicidal compound. In some embodiments, the instructions instruct to apply the TTO-containing composition at a dosage rate that at least 40% of the correct dosage rate as indicated by the manufacturer in the absence of application of a synthetic fungicidal compound. In some embodiments, the instructions instruct to apply the TTO-containing composition at a dosage rate that at least 45% of the correct dosage rate as indicated by the manufacturer in the absence of application of a synthetic fungicidal compound. In some embodiments, the instructions instruct to apply the TTO-containing composition at a dosage rate that at least 50% of the correct dosage rate as indicated by the manufacturer in the absence of application of a synthetic fungicidal compound. In some embodiments, the instructions instruct to apply the TTO-containing composition at a dosage rate that at least 55% of the correct dosage rate as indicated by the manufacturer in the absence of application of a synthetic fungicidal compound. In some embodiments, the instructions instruct to apply the TTO-containing composition at a dosage rate that at least 60% of the correct dosage rate as indicated by the manufacturer in the absence of application of a synthetic fungicidal compound. In some embodiments, the instructions instruct to apply the TTO-containing composition at a dosage rate that at least 65% of the correct dosage rate as indicated by the manufacturer in the absence of application of a synthetic fungicidal compound. In some embodiments, the instructions instruct to apply the TTO-containing composition at a dosage rate that at least 70% of the correct dosage rate as indicated by the manufacturer in the absence of application of a synthetic fungicidal compound. In some embodiments, the instructions instruct to apply the TTO-containing composition at a dosage rate that at least 75% of the correct dosage rate as indicated by the manufacturer in the absence of application of a synthetic fungicidal compound.

In some embodiments, the synthetic fungicidal compound is selected from the group consisting of demethylation inhibitors (DMIs), Amines, Quinone outside Inhibitors (QoIs), Anilinopyrimidines (APs), and Benzimidazoles, Carboxamides, Dithiocarbamates, Morpholines, and copper or a salt thereof.

In some embodiments, the fungicidal compound is a demethylation inhibitor (DMI) selected from the group consisting of difenoconazole, cyproconazole, flusilazole, flutriafol, metconazole, myclobutanil, propiconazole, tebuconazole and tetraconazole. In some embodiments the DMI is selected from the group consisting of myclobutanil, propiconazole and tetraconazole. In some embodiments, the fungicidal compound is a DMI other than difenoconazole, cyproconazole, flusilazole, flutriafol, metconazole, myclobutanil, propiconazole, tebuconazole and tetraconazole. In some embodiments the DMI is selected from the group consisting of azaconazole, bitertanol, bromuconazole, diniconazole, epoxiconazole, etaconazole, fenbuconazole, fluquinconazole, hexaconazole, imibenconazole, ipconazole, penconazole, prothioconazole, simeconazole, triadimefon, triadimenol and triticonazole. In some embodiments, the DMI is selected from triforine, pyrifenox, pyrisoxazole, fenarimol, nuarimol, imazalil, oxpoconazole, pefurazoate, prochloraz, and triflumizole. In some embodiments, the synthetic fungicidal compound is an amine fungicidal compound selected from the group consisting of spiroxamine, fenpropimorph and tridemorph. In some embodiments, the synthetic fungicidal compound is a QoI fungicidal compound selected from the group consisting of azoxystrobin, pyraclostrobin, kesoxym-methyl, picoxystrobin, pyrmetostrobin and trifloxystrobin. In some embodiments the synthetic fungicidal compound is selected from the group consisting of azoxystrobin and pyraclostrobin. In some embodiments, the synthetic fungicidal compound is a strobilurin other than azoxystrobin, pyraclostrobin, kesoxym-methyl, picoxystrobin, pyrmetostrobin and trifloxystrobin. In some embodiments the synthetic fungicidal compound is a QoI selected from the group consisting of azoxystrobin, coumoxystrobin, enoxastrobin, flufenoxystrobin, picoxystrobin, pyraoxystrobin, pyraclostrobin, pyrametostrobin, triclopyricarb, kresoxim-methyl, trifloxystrobin, dimoxystrobin, fenaminostrobin, metominostrobin, orysastrobin, famoxadone, fluoxastrobin, fenamidone and pyribencarb.

In some embodiments, the synthetic fungicidal compound is pyrimethanil. In some embodiments, the synthetic fungicidal compound is a benzimidazole selected from the group consisting of benomyl, carbendazim, thiabendazole, thiophanate and thiophanate-methyl. In some embodiments the synthetic fungicidal compound is the dithiocarbamate mancozeb.

In some embodiments, the synthetic fungicidal compound is chlorothalonil. In some embodiments, the synthetic fungicidal compound is copper or a copper salt.

In some embodiments, the synthetic fungicidal compound is a compound that is indicated for the treatment of common rust in corn, and the combination is applied to at least one corn plant. In some embodiments, the synthetic fungicidal compound is a compound that is indicated for the treatment of Cedar-apple rust, and the combination is applied to at least one apple plant. In some embodiments, the synthetic fungicidal compound is a compound that is indicated for the treatment of coffee rust, and the combination is applied to at least one coffee plant. In some embodiments, the synthetic fungicidal compound is a compound that is indicated for the treatment of stem rust of wheat, and the combination is applied to at least one wheat plant. In some embodiments, the synthetic fungicidal compound is a compound that is indicated for the treatment of soybean rust, and the combination is applied to at least one soybean plant. In some embodiments, the synthetic fungicidal compound is a compound that is indicated for the treatment of Crown Rust of Oats and Ryegrass, and the combination is applied to at least one oat or ryegrass plant. In some embodiments, the synthetic fungicidal compound is a compound that is indicated for the treatment of wheat rust in grains, and the combination is applied to at least one grain-yielding plant. In some embodiments, the synthetic fungicidal compound is a compound that is indicated for the treatment of yellow or black rust in cereals, and the combination is applied to at least one cereal-yielding plant. In some embodiments, the synthetic fungicidal compound is a compound that is indicated for the treatment of an infection caused by Uromyces appendeculatus, and the combination is applied to at least one bean plant. In some embodiments, the synthetic fungicidal compound is a compound that is indicated for the treatment of rust in stone fruits (peaches, apricots, nectarines and plums), and the combination is applied to at least one stone fruit plant. In some embodiments, the synthetic fungicidal compound is a compound that is indicated for the treatment of rust in onion and garlic plants, and the combination is applied to at least one onion or garlic plant. In some embodiments, the synthetic fungicidal compound is a compound that is indicated for the treatment of rust in beets, and the combination is applied to at least one beet plant. In some embodiments, the synthetic fungicidal compound is a compound that is indicated for the treatment of rust in fava bean plants, and the combination is applied to at least fava bean plant. In some embodiments, the synthetic fungicidal compound is a compound that is indicated for the treatment of rust in rose plants, and the combination is applied to at least rose plant.

In some embodiments, the synthetic fungicidal compound is selected from the group consisting of mancozeb, chlorothalonil, trifloxystrobin, krsoxim-methyl, orysastrobin, fluoxastrobin, azoxystrobin, pyraclostrobin, dimoxystrobin, picoxystrobin, carbendazim, thiophanate-methyl, thiophanate, thiabendazole, benomyl, boscalid, penthiopyrad, thifluzamide, bixafen, fluopyram, isopyrazam, fenpropimorph, fenpropidin, fenarimol, triforine, spiroxamine, tridemorph, elemental sulfur, quinoxyfen, meptyl dinocap, bupirimate, proquinazid, metrafenone, cyflufenamid, tebuconazole, epoxiconazole, propiconazole, prothioconazole, cyproconazole, difenoconazole, metconazole, flusilazole, myclobutanil, flutriafol, triadimefon, penconazole, bitertanol, hexaconazole, triadimenol, tetraconazole, fluquinconazole, triticonazole, fenbuconazole, diniconazole, bromuconazole, ipconazole, simeconazole, imibenconazole, azaconazole, etaconazole and diclobutrazol.

In some embodiments, the treatment is prophylactic treatment. In some embodiments, the treatment is curative.

There is also provided, in accordance with an embodiment of the invention, a composition comprising tea tree oil (TTO) and at least one synthetic fungicidal compound that is active against a fungus of the phylum basidiomycota. In some embodiments the fungal infection is caused by a member of class Pucciniomycetes. In some embodiments the fungal infection is caused by a member of the order Pucciniales. In some embodiments, the composition contains both the TTO and the at least one synthetic fungicidal compound at concentrations that allow the composition to be applied to a plant infected with an infection caused by a fungus of the group basidiomycota to treat the infection without at least one of (a) inducing phytoxicity in the plant and (b) violating government regulations. In some embodiments, the composition contains both the TTO and the at least one synthetic fungicidal compound at concentrations that require the composition to be diluted prior to application to a plant infected with an infection caused by a fungus of the group basidiomycota in order to treat the infection without at least one of (a) inducing phytoxicity in the plant and (b) violating government regulations. In some embodiments, the composition further comprises at least one of a mineral oil and an emulsifier. In some embodiements the emulsifier is an ammonium alkali metal salt of a C₆-C₂₆ fatty acid or a mixture of such salts. In some embodiments, the emulsifier is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates.

In some embodiments, the concentration of the synthetic fungicidal compound is not greater than 95% of the concentration of the synthetic fungicidal compound in fungicidal compositions prepared in accordance with the manufacturer's instructions in the absence of TTO. In some embodiments, the concentration of the synthetic fungicidal compound is not greater than 90% of the concentration of the synthetic fungicidal compound in fungicidal compositions prepared in accordance with the manufacturer's instructions in the absence of TTO. In some embodiments, the concentration of the synthetic fungicidal compound is not greater than 85% of the concentration of the synthetic fungicidal compound in fungicidal compositions prepared in accordance with the manufacturer's instructions in the absence of TTO. In some embodiments, the concentration of the synthetic fungicidal compound is not greater than 80% of the concentration of the synthetic fungicidal compound in fungicidal compositions prepared in accordance with the manufacturer's instructions in the absence of TTO. In some embodiments, the concentration of the synthetic fungicidal compound is not greater than 75% of the concentration of the synthetic fungicidal compound in fungicidal compositions prepared in accordance with the manufacturer's instructions in the absence of TTO. In some embodiments, the concentration of the synthetic fungicidal compound is not greater than 70% of the concentration of the synthetic fungicidal compound in fungicidal compositions prepared in accordance with the manufacturer's instructions in the absence of TTO. In some embodiments, the concentration of the synthetic fungicidal compound is not greater than 65% of the concentration of the synthetic fungicidal compound in fungicidal compositions prepared in accordance with the manufacturer's instructions in the absence of TTO. In some embodiments, the concentration of the synthetic fungicidal compound is not greater than 60% of the concentration of the synthetic fungicidal compound in fungicidal compositions prepared in accordance with the manufacturer's instructions in the absence of TTO. In some embodiments, the concentration of the synthetic fungicidal compound is not greater than 55% of the concentration of the synthetic fungicidal compound in fungicidal compositions prepared in accordance with the manufacturer's instructions in the absence of TTO. In some embodiments, the concentration of the synthetic fungicidal compound is not greater than 50% of the concentration of the synthetic fungicidal compound in fungicidal compositions prepared in accordance with the manufacturer's instructions in the absence of TTO. In some embodiments, the concentration of the synthetic fungicidal compound is not greater than 45% of the concentration of the synthetic fungicidal compound in fungicidal compositions prepared in accordance with the manufacturer's instructions in the absence of TTO. In some embodiments, the concentration of the synthetic fungicidal compound is not greater than 40% of the concentration of the synthetic fungicidal compound in fungicidal compositions prepared in accordance with the manufacturer's instructions in the absence of TTO. In some embodiments, the concentration of the synthetic fungicidal compound is not greater than 35% of the concentration of the synthetic fungicidal compound in fungicidal compositions prepared in accordance with the manufacturer's instructions in the absence of TTO. In some embodiments, the concentration of the synthetic fungicidal compound is not greater than 30% of the concentration of the synthetic fungicidal compound in fungicidal compositions prepared in accordance with the manufacturer's instructions in the absence of TTO. In some embodiments, the concentration of the synthetic fungicidal compound is at least 40% of the concentration of the synthetic fungicidal compound in fungicidal compositions prepared in accordance with the manufacturer's instructions in the absence of TTO. In some embodiments, the concentration of the synthetic fungicidal compound is at least 45% of the concentration of the synthetic fungicidal compound in fungicidal compositions prepared in accordance with the manufacturer's instructions in the absence of TTO. In some embodiments, the concentration of the synthetic fungicidal compound is at least 50% of the concentration of the synthetic fungicidal compound in fungicidal compositions prepared in accordance with the manufacturer's instructions in the absence of TTO. In some embodiments, the concentration of the synthetic fungicidal compound is at least 55% of the concentration of the synthetic fungicidal compound in fungicidal compositions prepared in accordance with the manufacturer's instructions in the absence of TTO. In some embodiments, the concentration of the synthetic fungicidal compound is at least 60% of the concentration of the synthetic fungicidal compound in fungicidal compositions prepared in accordance with the manufacturer's instructions in the absence of TTO. In some embodiments, the concentration of the synthetic fungicidal compound is at least 65% of the concentration of the synthetic fungicidal compound in fungicidal compositions prepared in accordance with the manufacturer's instructions in the absence of TTO. In some embodiments, the concentration of the synthetic fungicidal compound is at least 70% of the concentration of the synthetic fungicidal compound in fungicidal compositions prepared in accordance with the manufacturer's instructions in the absence of TTO. In some embodiments, the concentration of the synthetic fungicidal compound is at least 75% of the concentration of the synthetic fungicidal compound in fungicidal compositions prepared in accordance with the manufacturer's instructions in the absence of TTO.

In some embodiments, the concentration of the TTO is less than the concentration of the TTO in fungicidal compositions prepared in accordance with the manufacturer's instructions in the absence of a synthetic fungicidal compound. In some embodiments, the concentration of the TTO is not greater than 95% of the concentration of the TTO in fungicidal compositions prepared in accordance with the manufacturer's instructions in the absence of a synthetic fungicidal compound. In some embodiments, the concentration of the TTO is not greater than 90% of the concentration of the TTO in fungicidal compositions prepared in accordance with the manufacturer's instructions in the absence of a synthetic fungicidal compound. In some embodiments, the concentration of the TTO is not greater than 85% of the concentration of the TTO in fungicidal compositions prepared in accordance with the manufacturer's instructions in the absence of a synthetic fungicidal compound. In some embodiments, the concentration of the TTO is not greater than 80% of the concentration of the TTO in fungicidal compositions prepared in accordance with the manufacturer's instructions in the absence of a synthetic fungicidal compound. In some embodiments, the concentration of the TTO is not greater than 75% of the concentration of the TTO in fungicidal compositions prepared in accordance with the manufacturer's instructions in the absence of a synthetic fungicidal compound. In some embodiments, the concentration of the TTO is not greater than 70% of the concentration of the TTO in fungicidal compositions prepared in accordance with the manufacturer's instructions in the absence of a synthetic fungicidal compound. In some embodiments, the concentration of the TTO is not greater than 65% of the concentration of the TTO in fungicidal compositions prepared in accordance with the manufacturer's instructions in the absence of a synthetic fungicidal compound. In some embodiments, the concentration of the TTO is not greater than 60% of the concentration of the TTO in fungicidal compositions prepared in accordance with the manufacturer's instructions in the absence of a synthetic fungicidal compound. In some embodiments, the concentration of the TTO is not greater than 55% of the concentration of the TTO in fungicidal compositions prepared in accordance with the manufacturer's instructions in the absence of a synthetic fungicidal compound. In some embodiments, the concentration of the TTO is not greater than 50% of the concentration of the TTO in fungicidal compositions prepared in accordance with the manufacturer's instructions in the absence of a synthetic fungicidal compound. In some embodiments, the concentration of the TTO is not greater than 45% of the concentration of the TTO in fungicidal compositions prepared in accordance with the manufacturer's instructions in the absence of a synthetic fungicidal compound. In some embodiments, the concentration of the TTO is not greater than 40% of the concentration of the TTO in fungicidal compositions prepared in accordance with the manufacturer's instructions in the absence of a synthetic fungicidal compound. In some embodiments, the concentration of the TTO is not greater than 35% of the concentration of the TTO in fungicidal compositions prepared in accordance with the manufacturer's instructions in the absence of a synthetic fungicidal compound. In some embodiments, the concentration of the TTO is not greater than 30% of the concentration of the TTO in fungicidal compositions prepared in accordance with the manufacturer's instructions in the absence of a synthetic fungicidal compound. In some embodiments, the concentration of the TTO is at least 40% of the concentration of the TTO in fungicidal compositions prepared in accordance with the manufacturer's instructions in the absence of a synthetic fungicial composition. In some embodiments, the concentration of the TTO is at least 45% of the concentration of the TTO in fungicidal compositions prepared in accordance with the manufacturer's instructions in the absence of a synthetic fungicial composition. In some embodiments, the concentration of the TTO is at least 50% of the concentration of the TTO in fungicidal compositions prepared in accordance with the manufacturer's instructions in the absence of a synthetic fungicial composition. In some embodiments, the concentration of the TTO is at least 55% of the concentration of the TTO in fungicidal compositions prepared in accordance with the manufacturer's instructions in the absence of a synthetic fungicial composition. In some embodiments, the concentration of the TTO is at least 60% of the concentration of the TTO in fungicidal compositions prepared in accordance with the manufacturer's instructions in the absence of a synthetic fungicial composition. In some embodiments, the concentration of the TTO is at least 65% of the concentration of the TTO in fungicidal compositions prepared in accordance with the manufacturer's instructions in the absence of a synthetic fungicial composition. In some embodiments, the concentration of the TTO is at least 70% of the concentration of the TTO in fungicidal compositions prepared in accordance with the manufacturer's instructions in the absence of a synthetic fungicial composition. In some embodiments, the concentration of the TTO is at least 75% of the concentration of the TTO in fungicidal compositions prepared in accordance with the manufacturer's instructions in the absence of a synthetic fungicial composition.

In some embodiments, the synthetic fungicidal compound is selected from the group consisting of demethylation inhibitors (DMIs), Amines, Quinone outside Inhibitors (QoIs), Anilinopyrimidines (APs), and Benzimidazoles, Carboxamides, Dithiocarbamates, Morpholines, and copper or a salt thereof.

In some embodiments, the fungicidal compound is a demethylation inhibitor (DMI) selected from the group consisting of difenoconazole, cyproconazole, flusilazole, flutriafol, metconazole, myclobutanil, propiconazole, tebuconazole and tetraconazole. In some embodiments the DMI is selected from the group consisting of myclobutanil, propiconazole and tetraconazole. In some embodiments, the fungicidal compound is a DMI other than difenoconazole, cyproconazole, flusilazole, flutriafol, metconazole, myclobutanil, propiconazole, tebuconazole and tetraconazole. In some embodiments the DMI is selected from the group consisting of azaconazole, bitertanol, bromuconazole, diniconazole, epoxiconazole, etaconazole, fenbuconazole, fluquinconazole, hexaconazole, imibenconazole, ipconazole, penconazole, prothioconazole, simeconazole, triadimefon, triadimenol and triticonazole. In some embodiments, the DMI is selected from triforine, pyrifenox, pyrisoxazole, fenarimol, nuarimol, imazalil, oxpoconazole, pefurazoate, prochloraz, and triflumizole. In some embodiments, the synthetic fungicidal compound is an amine fungicidal compound selected from the group consisting of spiroxamine, fenpropimorph and tridemorph. In some embodiments, the synthetic fungicidal compound is a QoI fungicidal compound selected from the group consisting of azoxystrobin, pyraclostrobin, kesoxym-methyl, picoxystrobin, pyrmetostrobin and trifloxystrobin. In some embodiments the synthetic fungicidal compound is selected from the group consisting of azoxystrobin and pyraclostrobin. In some embodiments, the synthetic fungicidal compound is a strobilurin other than azoxystrobin, pyraclostrobin, kesoxym-methyl, picoxystrobin, pyrmetostrobin and trifloxystrobin. In some embodiments the synthetic fungicidal compound is a QoI selected from the group consisting of azoxystrobin, coumoxystrobin, enoxastrobin, flufenoxystrobin, picoxystrobin, pyraoxystrobin, pyraclostrobin, pyrametostrobin, triclopyricarb, kresoxim-methyl, trifloxystrobin, dimoxystrobin, fenaminostrobin, metominostrobin, orysastrobin, famoxadone, fluoxastrobin, fenamidone and pyribencarb.

In some embodiments, the synthetic fungicidal compound is pyrimethanil. In some embodiments, the synthetic fungicidal compound is a benzimidazole selected from the group consisting of benomyl, carbendazim, thiabendazole, thiophanate and thiophanate-methyl. In some embodiments the synthetic fungicidal compound is the dithiocarbamate mancozeb.

In some embodiments, the synthetic fungicidal compound is chlorothalonil. In some embodiments, the synthetic fungicidal compound is copper or a copper salt.

There is also provided, in accordance with an embodiment of the invention, a plant or a portion thereof which has been treated in accordance with a method in accordance with an embodiment of the invention. In some embodiments, the plant is selected from the group consisting of corn, apple coffee, wheat, Kentucky bluegrass, soybean, oats, ryegrass, bean, a grain plant, a cereal plant, a stone fruit (peach, apricot, nectarine or plum) plant, an onion or garlic plant, a beet plant, a fava bean plant, a rose plant, white pine, and daylily.

There is also provided, in accordance with an embodiment of the invention, a fruit or vegetable having on its skin or its leaves a synthetic fungicidal compound and tea tree oil or residue of tea tree oil. In some embodiments, the fruit or vegetable is selected from the group consisting of corn, apple coffee, wheat, soybean, oat, rye, bean, barley, spelt, onion, beets, fava beans, and stone fruits.

### DETAILED DESCRIPTION

There are provided in accordance with embodiments of the invention methods and compositions for treating infections in plants caused by fungi of the phylum basidiomycota. In some embodiments the fungal infection is caused by a member of class Pucciniomycetes. In some embodiments the fungal infection is caused by a member of the order Pucciniales. Examples of such fungi and their associated diseases are common rust in corn, caused by Puccinia sorghi; Cedar-apple rust, caused by Gymnosporangium juniperi-virginianae; Coffee rust, caused by Hemileia vastatrix; Stem rust of wheat and Kentucky bluegrass, caused by Puccinia graminis; Soybean Rust, also known as Asian Soybean Rust, which can be caused by either Phakopsora meibomiae or P. pachyrhizi; Crown Rust of Oats and Ryegrass, caused by Puccinia coronata; Bean rust, caused by Uromyces phaseoli; Wheat rust in grains, caused by Puccinia persistens subsp. triticina; and “Yellow” and “Black” rusts in cereals, caused respectively by P. sriiformis and P. graminis. Additional examples are Mycena citricolor (which infects coffee plants), Cronartium ribicola (White pine blister rust), Puccinia hemerocallidis (Daylily rust), and Uromyces appendeculatus (which infects beans). In general these methods involve applying to the leaves of the plant a combination of a tea tree oil (TTO) (which optionally may be in the form of a TTO-containing composition) and a synthetic fungicidal compound. While in some embodiments the invention may be practiced by using the synthetic fungicidal compound at its approved dosage level, in accordance with the manufacturer's instructions, in some embodiments the invention may be practiced by using the synthetic fungicial compound at a dosage level below that indicated by the manufacturer and/or approved by the relevant regulatory authorities and/or indicated by FRAC for use of the compound without TTO.

The inventors have found that use of a combination of TTO and a synthetic fungicidal compound, wherein the latter is used at a dosage level below that indicated by the manufacturer without TTO and/or approved by the relevant regulatory authorities and/or indicated by FRAC for use of the compound without TTO, can be as effective in combating infections caused by basidiomycota fungi, particularly those caused by fungi of the class pucciniomycetes and order pucciniales, as using the synthetic fungicidal compound alone at the approved level or using TTO alone at the level indicated by the manufacturer. Such combined use (which includes alternation), which may also elicit synergistic effects, facilitates a reduced chemical load on the plants, and increases their yield per hectare in comparison to currently indicated uses of commercially available synthetic fungicides used to combat basidiomycota infections such as soybean rust. Furthermore, it has been found that, contrary to conventional wisdom (such as is reflected in the FRAC literature), such combined use does not result in an increased likelihood of the development of fungicidal resistance.

In this application, the term “synthetic fungicidal compound” or “synthetic antifungal compound” is used to refer to those antifungal compounds that are synthesized as opposed to occurring as such in nature. Similarly, “TTO” or “tea tree oil” refers to an essential oil, usually but not necessarily obtained from the leaves of Melaleuca alternifolia, Melaleuca dissitiflora or Melaleuca linariifolia and usually being clear and generally colorless to pale yellow in color, which meets ISO 4730 (2004) (“Oil of Melaleuca, Terpinen-4-ol type”, available from the ISO at http://www.iso.org/iso/iso_catalogue/catalogue_tc/catalogue_detail.htm?csnumber=37033).

It will also be appreciated that synthetic fungicidal compounds are generally sold not as the pure chemical compound but as part of of a composition that contains other ingredients, which is typically called a “formulation”. In some cases, the formulation as sold contains two active ingredients, each operating on the target fungus by a different mechanism of action. The formulation is sold with a label or other instructions for use, which in many countries must be approved by a governmental regulatory body. These instructions may instruct the end-user to dilute the formulation in a particular manner, or may instruct the end-user to use the formulation as sold. In either case, the instructions will indicate a minimum dosage to be used for each type of crop with which the formulation is to be used, for example X liters of the formulation (which the manufacturer has provided at a concentration of Q grams of active ingredient per liter and may have indicated should be diluted to W grams of active ingredient/liter before use) per Y hectares of crop, as well as how the formulation should be applied to the crop (e.g. by spraying). The manufacturer, or a trade group like FRAC, will often also indicate a maximum number of applications per growing season. These instructions are given not only to increase the likelihood of efficacy of the fungicide, but also to minimize the likelihood of the development of fungicidal resistance in the treated fungus or fungi. Thus, in the context of this application, when reference is made to “a dosage rate that is less than the rate indicated by the manufacturer as being the correct dosage rate in the absence of TTO” or “the concentration of the synthetic fungicidal compound in fungicidal compositions prepared in accordance with the manufacturer's instructions in the absence of TTO” or the like, it will be understood that this refers to such a minimum dosage, as would be understood by one skilled in the art even if the manufacturer of the particular fungicidal formulation in question did not indicate such a minimum dosage. The same is true regarding TTO and TTO-containing compositions, mutatis mutandis, when reference is made herein to a dosage rate, concentration or the like for TTO or for a TTO-containing a composition that is “indicated by the manufacturer as being the correct” dosage rate or concentration or the like “in the absence of a synthetic fungicidal composition”.

It will also be appreciated that as used herein, unless indicated otherwise “treatment” refers to both the prophylactic treatment of plants as well as the curative treatment thereof. It will be appreciated that prophylactic treatment includes both preventing ascomycetes infection as well as delaying the onset of such infection, and that curative treatment includes both suppressing or eradicating existing fungus as well as delaying or preventing the worsening of an existing infection. It will be appreciated by those skilled in the art that the effectiveness of a particular synthetic fungicidal compound for prophylactic or curative treatment will depend on its mode of action, as basidiomycetes have different life-cycle phases at which they are susceptible to different compounds. (OK)

As stated, the synthetic fungicidal compound will generally be supplied as a composition with other ingredients, i.e. as a formulation, although practice of embodiments of the invention is not limited to such cases, and, as is known in the art, it is possible to formulate the raw chemical into a composition which can then be further mixed or diluted for use in accordance with embodiments of the invention. For example, if the raw synthetic fungicidal compound is not water soluble or is only sparingly soluble in water, emulsifiable concentrates or emulsions may be prepared by dissolving the synthetic fungicidal compound in an organic solvent optionally containing a wetting or emulsifying agent and then adding the mixture to water which may also contain a wetting or emulsifying agent. Suitable organic solvents include aromatic solvents such as alkylbenzenes and alkylnaphthalenes, ketones such as cyclohexanone and methylcyclohexanone, chlorinated hydrocarbons such as chlorobenzene and trichlorethane, and alcohols such as benzyl alcohol, furfuryl alcohol, butanol and glycol ethers. Suspension concentrates of largely insoluble solids may be prepared by ball or bead milling with a dispersing agent with a suspending agent included to stop the solid settling. By including suitable additives, for example additives for improving the distribution, adhesive power and resistance to rain on treated surfaces, the different compositions can be better adapted for various utilities. Emulsifiable concentrates and suspension concentrates will normally contain surfactants, e.g. a wetting agent, dispersing agent, emulsifying agent or suspending agent. These agents can be cationic, anionic or non-ionic agents. Suitable cationic agents are, for example, quaternary ammonium compounds, for example, cetyltrimethylammonium bromide. Suitable anionic agents are soaps, salts of aliphatic monoesters of sulphuric acid (for example, sodium lauryl sulphate), and salts of sulphonated aromatic compounds (for example, sodium dodecylbenzenesulphonate, sodium, calcium or ammonium lignosulphonate, butylnaphthalene sulphonate, and a mixture of sodium diisopropyl- and triisopropylnaphthalene sulphonates). Suitable non-ionic agents are, for example, the condensation products of ethylene oxide with fatty alcohols such as oleyl or cetyl alcohol, or with alkyl phenols such as octyl- or nonylphenol and octylcresol. Other non-ionic agents are the partial esters derived from long chain fatty acids and hexitol anhydrides, the condensation products of the said partial esters with ethylene oxide, and the lecithins. Suitable suspending agents are hydrophilic colloids (for example, polyvinylpyrrolidone and sodium carboxymethylcellulose), and swelling clays such as bentonite or attapulgite. Compositions for use as aqueous dispersions or emulsions are generally supplied in the form of a concentrate containing a high proportion of the active ingredient, the concentrate being diluted with water before use. These concentrates should preferably be able to withstand storage for prolonged periods and after such storage be capable of dilution with water in order to form aqueous preparations which remain homogeneous for a sufficient time to enable them to be applied by conventional spray equipment. The concentrates may conveniently contain up to 95%, suitably 10-85%, for example 25-60%, by weight of the active ingredient. After dilution to form aqueous preparations, such preparations may contain varying amounts of the active ingredient depending upon the intended purpose, but an aqueous preparation containing 0.0005% to 10%, more often 0.01% to 10%, by weight of active ingredient may be used.

Similarly, the TTO will generally be supplied in the form of a composition, e.g. an oil-in-water emulsion, such as is described in US Patent Publication No. 2007/0237837 or as available commercially as Timorex Gold®. However, it will be appreciated that, as described e.g. in US Patent Publication No. 2007/0237837, it is possible to formulate TTO into a composition which can then be further mixed or diluted for use in accordance with embodiments of the invention.

Thus, for example, an aqueous solution of an ammonium or alkali metal salt of a C₆₋₂₆ fatty acid (or mixture of such fatty acids) may be prepared by mixing such a fatty acid with an aqueous solution of a base (or a mixture of bases) such as NaOH, KOH, Na₂CO₃, KHCO₃, and NH₃; TTO may then be mixed into this solution. Depending on the proportions of water, TTO, and fatty acid salt, the result will be either a water-in-oil emulsion (if the TTO is the predominant ingredient) or an oil-in-water emulsion (if the water is the predominant ingredient). Alternatively, TTO and a C₆-C₂₆ fatty acid or mixture of such fatty acids may be mixed together, and an aqueous solution of a base (or a mixture of bases) such as NaOH, KOH, Na₂CO₃, KHCO₃, and NH₃ may be mixed into this mixture. If desired, this mixture may be further diluted by further addition of water. Depending on the proportions of water, TTO, and fatty acid and base, the result will be either a water-in-oil emulsion (if the TTO is the predominant ingredient) or an oil-in-water emulsion (if the water is the predominant ingredient). Other organic ingredients, such as other emulsifiers, co-solvents such as C₁₋₈ alcohols (such as methanol, ethanol, propanol, butanol and the like) or petroleum distillates having a suitable carbon chain range and distribution, and additional etheric oils, may be added at any stage of the mixing process. This composition will generally be further diluted in water prior to use, so that the concentration of TTO in the composition that is actually applied to a plant will generally range from about 0.01 wt. % to about 5 wt. %, although in principle the weight percentage of TTO may be somewhat higher, provided it is not so high that it exerts a phytotoxic effect on the plant being treated. Also, in principle it is possible to use other liquids to dilute the composition, e.g. methanol or ethanol, although water is most commonly used; as mentioned, alcohols, e.g. C₁₋₈ alcohols such as ethanol, methanol, isopropanol, butanol, and the like, in small amounts, may be also be useful for formulating the material.

The fatty acids themselves, which may be utilized in a suitable weight ratio relative to the TTO, as is known in the art (see e.g. US 2007/0237837 or WO 2004/021792), may be saturated or unsaturated and straight- or branched-chain. Examples of such are myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid; caproic acid (hexanoic acid), enanthic acid (heptanoic acid), caprylic acid (octanoic acid), pelargonic acid (nonanoic acid), capric acid (decanoic acid), undecylic acid (undecanoic acid), lauric acid (dodecanoic acid), tridecylic acid (tridecanoic acid), myristic acid (tetradecanoic acid), pentadecylic acid (pentadecanoic acid), palmitic acid (hexadecanoic acid), margaric acid (heptadecanoic acid), stearic acid (octadecanoic acid), nonadecylic acid (nonadecanoic acid), arachidic acid (eicosanoic acid), heneicosylic acid (heneicosanoic acid), behenic acid (docosanoic acid), tricosylic acid (tricosanoic acid), lignoceric acid (tetracosanoic acid), pentacosylic acid (pentacosanoic acid) and cerotic acid (hexacosanoic acid). Other emulsifiers which may additionally or alternatively be incorporated into the compositions prior to futher dilution with water include, for example, ethoxylated fatty acids, ethoxylated castor oils, sorbitans ester, dodecylbenzene sulphonates, and ethoxylated tristyrylphenol phosphates; as will be appreciated by those skilled in the art, these emulsifiers are generally synthetic emulsifiers. Other examples of suitable emulsifiers (some of which, as will be appreciated by persons skilled in the art, are also surfactants) are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors, methylcellulose, nonyl phenol ethoxylates (such as nonylphenol polyglycol ether with 4 to 30 EO), octyl phenol ethoxylates (such as iso-octylphenol polyglycol ether with EO), tributyl phenol ethoxylates (such as tri-sec-butylphenol polyglycol ether with 4 to 50 EO), tristyrylphenol phosphate (TSP) ethoxylates (such as 2,4,6-tri-(1-phenylethyl)-phenol polyglycol ether with 20 EO), castor oil ethoxylates (such as castor oil ethoxylate with 6 to 54 EO), alkoxylates (such as fatty alcohol block polyalkoxylate with EO), fatty alcohol ethoxylates (such as unsaturated fatty alcohol polyglycol ether with 20 to 80 EO), oxo alcohol polyglycol ether with 4 to 11 EO, alkylbenzene sulfonates (such as alkyl benzene sulfonate triethanolamine salt, alkyl benzene sulfonate sodium salt, alkyl benzene sulfonate calcium salt), fatty acid ethoxylate with 6 to 40 EO, and dodecylbenzene sulphonates (such as calcium dodecyl benzen sulfonate); as is known in the art, “EO” refers to the degree of ethoxylation. It will also be appreciated that such emulsifiers, whether synthetic or natural, may be used instead of the fatty acid salts described above. Mineral oils may also be incorporated into the compositions, either prior to, during or after dilution; if prior to application to the plant, the TTO-containing compositions are also mixed with the synthetic fungicidal compound or formulation containing the synthetic fungicidal compound, the mineral oil(s) or emulsifier(s) may also be added at this stage.

Thus, in some embodiments, compositions containing TTO and the synthetic fungicial compound, respectively, will be mixed together and, if necessary, diluted, for application to one or plants. In other embodiments, the TTO and synthetic fungicidal compound may be formulated together, e.g. by methods known in the art or developed in the future, and packaged with appropriate instructions for the end-user. From the description above it will be apparent that compositions containing both TTO and the synthetic fungicidal compound may be made by first making a composition containing TTO and an emulsifier, and then mixing in the synthetic fungicidal compound. It will also be appreciated that another way to prepare compositions containing both TTO and the synthetic fungicidal compound is to mix the TTO into a formulation that already contains the synthetic fungicidal compound, such as an existing commercial formulation. If such formulation already contains a sufficient amount of a suitable emulsifier, then the TTO may be mixed directly with the formulation; if the formulation does not contain a sufficient amount of a suitable emulsifier, then such an emulsifier may be added prior to or concomitantly with the mixing in of the TTO. The resulting formulation, which contains both TTO and the sythetic fungicidal compound, may then be diluted as necessary prior to application to the plant. Alternatively, the formulation may be diluted prior to the mixing in of the TTO. In some cases, it may be possible to dissolve the raw synthetic fungicidal compound in pure TTO or in a TTO-containing composition, and to then formulate this into a desired emulsion by addition of e.g. water and a suitable surfactant, optionally with one or more of a co-surfactant, co-solvent, and other inert ingredient; the emulsion may be suitable for dilution e.g. by tank mixing or may be sufficiently dilute for use on plants. Additionally, as will be appreciated by those skilled in the art, the TTO-containing compositions, whether or not they also contain a synthetic fungicidal compound, may be formulated with adjuvants, such as organosilicates like Silwet 77, clays, talc, acids (such as acetic acid or hydrochloric acid), fatty acid oils, gelatin, resins, gums, polyoxyethylene glycols, sulfated alcohols, fatty acid esters, alkyl sulfonates, petroleum sulfonates, polyol fatty acid esters, polyethoxylated fatty acid esters, aryl alkyl polyoxyethylen glycols, alkyl amine acetates, alkyl aryl sulfonates, alkyl phosphates, and polyhydric alcohols. Such TTO-containing compositions, whether or not they also contain a synthetic fungicidal compound, may also be formulated with preservatives such as 1,2-benzisothiazolin-3-one, and/or with stabilizers such as resins, polyoxyethylene glycols, and gums (e.g. xanthan gum and gum Arabic). It will also be appreciated that in accordance with some embodiments, the use of the TTO and the synthetic fungicidal compound may be alternated, which can also result in a lowering of the likelihood of development of fungicidal resistance without sacrificing performance.

### Example 1

The effect of application of a TTO-containing composition (Timorex Gold®), alone and in combination with tebuconazole (simultaneous and in alternation), on coffee plant rust, was tested, by applying the compositions to coffee plant leaves and observing the degree and severity of infection later. Treatment with tebuconazole alone or in combinataion with Timorex Gold (simultaneous application and application in alternation) resulted in a higher retention of leaves by the plants, and overall lower severity of the disease. Treatment with Timorex Gold alone enabled retention of leaves, but the severity of the infection was higher than when used in alternation with tebuconazole or with combination.

### Example 2

### Control of Rust in Garlic Plants

Organically grown garlic plants were treated with a 53.8% copper hydroxide solution, Timorex Gold, or a mixture of the two. These were diluted before use as shown in the tables. The plants were sprayed six times, on the first day of the trial and then approximately every six days thereafter. Observations were made on days 1 (before spraying), 29 and 40 of the trial. The results are shown in the table below; d.a.a.=days after application; numbers are presented as % of disease severity on leaves. The effectiveness may have been comprised by the relatively large amount of rain that fell during the trial.

Treatments were applied in a randomized complete block, with 5 replications per treatment. Plot size in each instance was of 6 m length, containing 20 plants. Fungicidal treatment was applied using backpack sprayer equipped with a mist blower (STHIL 340) to spray a volume of 300 liter/ha. Disease severity was evaluated by determining the leaf area covered with rust (disease severity) on each of 20 leaves randomly selected per each replicate. To analyze the results, an arc-sin transformation was performed on the raw data, and analysis of variance (ANOVA) using the SAS GLM procedure was applied to the transformed data. The Tukey-Kramer Test was applied to determine whether differences between treatments were significant. The results are summarized in the tables below. In the tables, “a”, “b” and “c”, refer to differences in statistical analysis that are familiar to users of the Tukey-Kramer test.

| | | Six days after fifth application | |
|---|---|---|---|
| | | | Effectiveness in |
| | Day 0 | % of | eradicating |
| | % of infected area | infected area | relative to control |
| Control | 0.5 a | 57.5 a | — |
| Copper | 0.2 a | 27.0 b | 53.0 |
| hydroxide 0.25% | | | |
| TG 0.5% | 0.0 a | 29.1 b | 49.4 |
| TG 1.0% | 0.2 a | 26.2 b | 54.4 |
| TG 2.0% | 0.7 a | 23.3 b | 59.5 |

| | 40 d.a.a.: | 40 d.a.a. % green |
|---|---|---|
| Treatment | % green | relative to control |
| Control | 19.6 a | — |
| Copper hydroxide 0.25% | 60.0 a | 206.1 |
| TG 0.5% | 42.1 a | 114.8 |
| TG 1% | 47.5 a | 142.3 |
| TG 2% | 38.3 a | 95.4 |
| TG 1% + Copper hydroxide 0.125% | 59.2 a | 202.0 |

### Example 3

### Control of Rust in Organically Grown Green Onions

In a manner similar to that in Example 2, the effect of TG and the copper hydroxide solution were tested on organically grown green onions, by application at a rate of 500 l/ha. The results are shown in the two tables below.

| | First | | | | |
|---|---|---|---|---|---|
| | evaluation, | Second evaluation, | | Third evaluation, | |
| | before | 2 days after | | on day of fourth | |
| | treatment | second treatment | | treatement | |
| | % area | % area | | % area | |
| | infected | infected | Efficacy of | infected | Efficacy of |
| | by rust | by rust | treatment, % | by rust | treatment, % |
| Control | 0.5 a | 4.8 a | — | 12.0 a | — |
| Copper | 0.3 a | 1.8 ab | 62.1 | 2.5 b | 79.2 |
| hydroxide | | | | | |
| 2.5 g/l | | | | | |
| TG 0.25% | 0.5 a | 2.8 ab | 41.4 | 5.3 b | 55.6 |
| TG 0.5% | 0.2 a | 1.8 ab | 62.1 | 3.3. b | 72.2 |
| TG 1.0% | 0.2 a | 1.2 b | 75.9 | 2.3 b | 80.6 |

| | 4th evaluation, 1 day | | 5th evaluation, on day | | 6th evaluation, 7 days | |
|---|---|---|---|---|---|---|
| | after 5th treatment | | of 7th treatment | | after 7th treatment | |
| | % area | | % area | | % area | |
| | infected by | Efficacy of | infected by | Efficacy of | infected by | Efficacy of |
| | rust | treatment, % | rust | treatment, % | rust | treatment, % |
| Control | 28.7 a | — | 54.2 a | — | 75.0 a | — |
| Copper | 8.5 b | 70.3 | 12.5 b | 76.9 | 18.7 b | 75.1 |
| hydroxide 2.5 g/l | | | | | | |
| TG 0.25% | 12.2 b | 57.6 | 15.0 b | 72.3 | 16.7 b | 77.8 |
| TG 0.5% | 7.5 b | 73.8 | 4.7 b | 91.4 | 6.0 c | 92.0 |
| TG 1.0% | 3.7 b | 87.2 | 2.0 b | 96.3 | 2.0 c | 97.3 |

### Example 4

Timorex Gold used alone was found to control soybean rust to a degree comparable to tebuconazole, flutriafol, and a mixture of epoxiconazole and carbendaz.

### Example 5

Better treatment of soybean rust was effected using a mixture of Timorex Gold and (a) azoxystrobin or (b) a mixture of azoxystrobin and cyproconazole than either using the ingredients separately.

### Example 6

It was found that better control of Hemileia vastatrix in coffee was effected using combinations of Timorex Gold with (a) pyraclostrobin or (b) a mixture of azoxystrobin and cyproconazole than using the ingredients separately.

### Example 7

It was found that better control of Puccinia triticina and greater crop yields in wheat were effected using combinations of Timorex Gold with azoxystrobin than using the ingredients separately.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the general combination of parts that perform the same functions as exemplified in the embodiments, and includes both combinations and sub-combinations of the various features described hereinabove as well as variations and modifications thereof, which would occur to persons skilled in the art upon reading the foregoing description.

1. A method for treating a plant infection caused by a fungus of the group basidiomycota, comprising applying to the plant a combination of tea tree oil (TTO) and a synthetic fungicidal compound.

2. The method according to claim 1, wherein the infection is caused by a member of class Pucciniomycetes.

3. The method of claim 2, wherein the infection is caused by a member of the order Pucciniales.

4. The method of claim 1, wherein the fungal infection is a rust infection.

5. The method of claim 4, wherein the infection is selected from the group consisting of common rust in corn, Cedar-apple rust, Coffee rust, Stem rust of wheat and Kentucky bluegrass, Soybean Rust, Crown Rust of Oats and Ryegrass, Bean rust, Wheat rust in grains, and “Yellow” and “Black” rusts in cereals, rust in stone fruits (peaches, apricots, nectarines and plums), rust in onion and garlic plants, rust in beets, rust in fava bean plants, rust in rose plants, white pine blister rust, and daylily rust.

6. The method of claim 1, wherein the fungal infection is caused by a member of the group consisting of Puccinia sorghi, Gymnosporangium juniperi-virginianae, Hemileia vastatrix, Puccinia graminis, Phakopsora meibomiae, P. pachyrhizi, Puccinia coronata, Uromyces phaseoli, Puccinia persistens subsp. triticina, P. sriiformis, P. graminis, Mycena citricolor, Cronartium ribicola, Puccinia hemerocallidis, Tranzschelia discolor, Puccinia alli, Uromyces beta, Uromyces faba, Phragmidium mucronatum or Phragmidium tuberculatum, Uromyces appendeculatus, Mycena citricolor, Cronartium ribicola, Puccinia hemerocallidis, and Uromyces appendeculatus.

7. The method according to claim 1 wherein the combination is applied to the leaves of the plant.

8. The method according to claim 7, wherein the TTO is applied as a TTO-containing composition.

9. The method according to claim 8 wherein the TTO-containing composition comprises TTO and an emulsifier, wherein the emulsifier (a) is an ammonium of alkali metal salt of a C₆-C₂₆ fatty acid a mixture of such salts or (b) is selected from the group consisting of ethoxylated fatty acids, ethoxylated castor oils, ethoxylated polyglycol ethers, alkoxylates, sorbitan esters, dodecylbenzene sulphonates, and ethoxylated tristyrylphenol phosphates.

10-11. (canceled)

12. The method of claim 9 wherein the TTO-containing composition is an oil-in-water emulsion.

13. The method of claim 12 wherein the TTO is present in the TTO-containing composition in an amount of from 0.01 wt. % to 10 wt. %.

14-41. (canceled)

42. The method according to claim 13 wherein the TTO-containing composition further comprises the synthetic fungicidal compound.

43. The method according to claim 12 wherein the combination is applied simultaneously.

44. The method according to claim 12 wherein the combination is applied as a single mixture.

45-48. (canceled)

49. The method according to claim 44, wherein at least one of the following is true: (a) the synthetic fungicidal compound is applied at a dosage rate that is less than the rate indicated by the manufacturer as being the correct dosage rate in the absence of TTO; (b) the TTO is applied at a dosage rate that is less than the rate indicated by the manufacturer as the rate used when the TTO is applied in the absence of a synthetic fungicidal compound.

50. The method according to claim 49 wherein the dosage rate at which the synthetic fungicidal compound is applied is not greater than 95% of the correct dosage rate as indicated by the manufacturer in the absence of TTO and is at least 40% of the correct dosage rate as indicated by the manufacturer in the absence of TTO.

51-72. (canceled)

73. The method of claim 49 wherein the dosage rate at which the TTO is applied is not greater than 95% of the correct dosage rate as indicated by the manufacturer in the absence of application of a synthetic fungicidal compound and at least 40% of the correct dosage rate as indicated by the manufacturer in the absence of application of a synthetic fungicidal compound.

74-94. (canceled)

95. A method according to claim 17 wherein the synthetic fungicidal compound is selected from the group consisting of demethylation inhibitors (DMIs), Amines, Quinone outside Inhibitors (QoIs), Anilinopyrimidines (APs), and Benzimidazoles, Carboxamides, Dithiocarbamates, Morpholines, and copper or a salt thereof.

96. The method according to claim 95 wherein at least one of the following is true: (a) the synthetic fungicidal compound is a demethylation inhibitor (DMI) selected from the group consisting of difenoconazole, cyproconazole, flusilazole, flutriafol, metconazole, myclobutanil, propiconazole, tebuconazole and tetraconazole, (b) the synthetic fungicidal compound is a DMI selected from the group consisting of azaconazole, bitertanol, bromuconazole, diniconazole, epoxiconazole, etaconazole, fenbuconazole, fluquinconazole, hexaconazole, imibenconazole, ipconazole, penconazole, prothioconazole, simeconazole, triadimefon, triadimenol and triticonazole, (c) the synthetic fungicidal compound is a DMI selected from the group consisting of triforine, pyrifenox, pyrisoxazole, fenarimol, nuarimol, imazalil, oxpoconazole, pefurazoate, prochloraz, and triflumizole, (d) the synthetic fungicidal compound is an amine fungicidal compound selected from the group consisting of spiroxamine, fenpropimorph and tridemorph, (e) the synthetic fungicidal compound is a QoI fungicidal compound selected from the group consisting of azoxystrobin, pyraclostrobin, kesoxym-methyl, picoxystrobin, pyrmetostrobin and trifloxystrobin, (f) the synthetic fungicidal compound is a QoI selected from the group consisting of azoxystrobin, coumoxystrobin, enoxastrobin, flufenoxystrobin, picoxystrobin, pyraoxystrobin, pyraclostrobin, pyrametostrobin, triclopyricarb, kresoxim-methyl, trifloxystrobin, dimoxystrobin, fenaminostrobin, metominostrobin, orysastrobin, famoxadone, fluoxastrobin, fenamidone and pyribencarb, (g) the synthetic fungicidal compound is pyrimethanil, (h) the synthetic fungicidal compound is a benzimidazole selected from the group consisting of benomyl, carbendazim, thiabendazole, thiophanate and thiophanate-methyl, (i) the synthetic fungicidal compound is mancozeb, and (j) the synthetic fungicidal compound is chlorothalonil.

97-110. (canceled)

111. The method of claim 95 wherein at least one of the following is true: (a) the synthetic fungicidal compound is a compound that is indicated for the treatment of common rust in corn, and the combination is applied to at least one corn plant; (b) the synthetic fungicidal compound is a compound that is indicated for the treatment of Cedar-apple rust, and the combination is applied to at least one apple plant; (c) the synthetic fungicidal compound is a compound that is indicated for the treatment of coffee rust, and the combination is applied to at least one coffee plant; (d) the synthetic fungicidal compound is a compound that is indicated for the treatment of stem rust of wheat, and the combination is applied to at least one wheat plant; (e) the synthetic fungicidal compound is a compound that is indicated for the treatment of soybean rust, and the combination is applied to at least one soybean plant; (f) the synthetic fungicidal compound is a compound that is indicated for the treatment of Crown Rust of Oats and Ryegrass, and the combination is applied to at least one oat or ryegrass plant; (g) the synthetic fungicidal compound is a compound that is indicated for the treatment of wheat rust in grains, and the combination is applied to at least one grain-yielding plant; (h) the synthetic fungicidal compound is a compound that is indicated for the treatment of yellow or black rust in cereals, and the combination is applied to at least one cereal-yielding plant; (i) the synthetic fungicidal compound is a compound that is indicated for the treatment of an infection caused by Uromyces appendeculatus, and the combination is applied to at least one bean plant; (j) the synthetic fungicidal compound is a compound that is indicated for the treatment of rust in stone fruits (peaches, apricots, nectarines and plums), and the combination is applied to at least one stone fruit plant; (k) the synthetic fungicidal compound is a compound that is indicated for the treatment of rust in onion and garlic plants, and the combination is applied to at least one onion or garlic plant; (l) the synthetic fungicidal compound is a compound that is indicated for the treatment of rust in beets, and the combination is applied to at least one beet plant; (m) the synthetic fungicidal compound is a compound that is indicated for the treatment of rust in fava bean plants, and the combination is applied to at least fava bean plant; and (n) the synthetic fungicidal compound is a compound that is indicated for the treatment of rust in rose plants, and the combination is applied to at least rose plant.

112-130. (canceled)
